(19) United States
(12) Patent Application Publication
(10) Pub. No.: US 2014/0095611 A1
(43) Pub. Date: Apr. 3, 2014

(54) PERSONALIZATION THROUGH DYNAMIC SOCIAL CHANNELS

(71) Applicant: WETPAINT.COM, INC., Seattle, WA (US)

(72) Inventors: Alex David Weinstein, Bellevue, WA (US); Bo Steven Finneman, Los Angeles, CA (US); Dmitry Frenkel, Bothell, WA (US); Peter Raymond Ondish, Saegertown, PA (US)

(73) Assignee: WETPAINT.COM, INC., Seattle, WA (US)

(21) Appl. No.: 13/797,311

(22) Filed: Mar. 12, 2013

Related U.S. Application Data
(60) Provisional application No. 61/708,455, filed on Oct. 1, 2012.

(51) Int. Cl. H04L 29/08

(52) U.S. Cl. CPC H04L 67/22
USPC 709/204

(57) ABSTRACT

Embodiments are directed towards dynamically managing a plurality of channels for providing content to users. New channels may be automatically generated based on sub-interest groups of existing channels, which may generate a hierarchy of channels, where new content may be posted and/or provided to the new channel, and/or a parent channel. The new channel may be proposed to a user, that accesses content on a channel, to invite the user to subscribe to the new channel. The proposed channel may be determined based on a weight of channels associated with the accessed content. Similarly, a proposed channel may be provided to a publisher for new content based on the weight of channels associated with the new content. Channels may be discontinued if a value of the channel falls below a predetermined threshold. Channels with overlapping characteristics may be merged together if the overlapping channels satisfy merging criteria.

### CROSS REFERENCE TO RELATED APPLICATIONS

This non-provisional patent application claims the benefit under 35 U.S.C. §119(e) of U.S. Provisional Patent Application, Ser. No. 61/708,455 filed on Oct. 1, 2012, entitled “Personalization Through Dynamic Social Channels,” which is incorporated herein by reference.

### TECHNICAL FIELD

The present invention relates generally to audience development/management, and more particularly, to dynamically managing social channels to provide content to users.

### BACKGROUND

Today, online media is a world where users typically have the option of choosing from multiple media properties for accessing content. The magnitude of different media properties and large amounts of content may create a digital space that is highly competitive and undifferentiated from a content perspective. As a result, the ability of a media property to attract and maintain users may impact the successfulness of the property

Typically media properties try to attract users by providing a vast array of content that covers multiple different interests in the hopes of attracting users. However, this approach may lack personalization for individual readers. For example, news about a particular celebrity may be provided to a reader as a mainstream interest, even though that reader may not want to read articles about that celebrity. Sometimes, these uninterested readers quickly abandon the media property because they do not quickly see an article that is interesting to them. As a result, the loyalty of the uninterested reader to the media property and/or publisher may be diminished, leading the uninterested reader to a different media property in the future. It is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of an environment in which embodiments of the invention may be implemented;

FIG. 2 shows an embodiment of a client device that may be included in a system such as that shown in FIG. 1;

FIG. 3 shows an embodiment of a network device that may be included in a system such as that shown in FIG. 1;

FIG. 4 illustrates a logical flow diagram generally showing one embodiment of an overview process for generating a new channel for a sub-interest of a channel;

FIG. 5 illustrates a logical flow diagram generally showing one embodiment of a process for generating a new channel for a similar sub-interest common to multiple channels;

FIG. 6 illustrates a logical flow diagram generally showing one embodiment of a process for determining a sub-interest group of a channel;

FIG. 7 illustrates a logical flow diagram generally showing one embodiment of a process for managing and providing a proposed channel to a user;

FIG. 8 illustrates a logical flow diagram generally showing one embodiment of a process for calculating an expected value of a proposed channel for a user;

FIG. 9 illustrates a logical flow diagram generally showing one embodiment of a process for determining which channel to post content;

FIG. 10 illustrates a logical flow diagram generally showing one embodiment of a process for determining content to cross promote on a channel;

FIG. 11 illustrates a logical flow diagram generally showing one embodiment of a process for determining when to discontinue a channel;

FIG. 12 illustrates a logical flow diagram generally showing one embodiment of a process for determining when to merge multiple channels;

FIGS. 13A-13B shows use case illustrations of embodiments of a hierarchy of channels resulting from a generation of a new channel for a sub-interest of another channel;

FIGS. 14A-14B shows use case illustrations of embodiments of a hierarchy of channels resulting from a generation of a new channel for a similar sub-interest common to multiple channels;

FIG. 15 illustrates a use case of an embodiment of a hierarchy of channels;

FIG. 16 illustrates a use case of an embodiment of a matrix that may be utilized to determine weights for cross-promoting content on different channels; and

FIG. 17 illustrates a system diagram of a use case embodiment of a system that may be utilized to implement embodiments of the invention.

### DETAILED DESCRIPTION

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “content” refers to digital data that may be communicated over a network to be remotely displayed by a computing device. Non-exhaustive examples of content include but are not limited to articles, blogs, movies, videos, music, sounds, pictures, illustrations, graphics, images, text, or the like. Content may also include summaries, briefs, snippets, headlines, or the like, of the content. In some embodiments, the content may include links, hyperlinks, or the like to the content. In some embodiments, each piece of content may include one or more features. These features may include, for example, a subject, topic, theme, trend, character, person, topic, keyword, date of creation, author, publisher/poster, or the like. In at least one of various embodiments, the features of a piece of content may also include traffic achieved for the content on a channel (i.e., a channel that the content is posted/provided).

As used herein, the term “channel” refers to a method of providing and/or otherwise distributing content from a publisher to a user. In some embodiments, a channel may contain content that is directed to an interest. An interest of a channel may be something that concerns, involves, draws the attention of, or arouses the curiosity of a user. In some embodiments, an interest of a channel may include a category having one or more sub-categories. Similarly, a channel interest may have one or more sub-interests. For example, an interest of a channel may be United States News, which may include a sub-interest of United States Sports Headlines. In some embodiments, the interest of a channel may be predefined, such as, by a publisher, channel administrator, or the like. In at least one embodiment, a sub-interest of a channel may be determined by employing embodiments described herein.

Channels may include, but are not limited to, email messages, text messages, web pages, social media pages, social media messages, physical mailings, telephone calls, or the like. Non-limiting, non-exhaustive examples of providing content to a user through a channel may include posting content or a link to content on a social media page, sending an email with content to a user, or the like. In some embodiments, users may subscribe to a channel by requesting content from a publisher through a channel, by signing up with a channel (e.g., signing up with an email distribution list), becoming a member of the channel (e.g., becoming a member of the publisher's social media page), or the like. Subscribing to a channel may be free or may include a monetary cost, which may be charged to a user and/or offset by advertising. In some embodiments, content may be posted and/or otherwise provided to a channel for one or more users. In other embodiments, content may be provided through a channel to one or more users.

The following briefly describes embodiments of the invention in order to provide a basic understanding of some aspects of the invention. This brief description is not intended as an extensive overview. It is not intended to identify key or critical elements, or to delineate or otherwise narrow the scope. Its purpose is merely to present some concepts in a simplified form as a prelude to the more detailed description that is presented later.

Briefly stated, various embodiments are directed to dynamically managing a plurality of channels for providing content to users. In at least one embodiment, dynamically generating new channels, discontinuing channels, and/or merging channels may enable users to subscribe to more personalized channels that fit the users' interests.

In at least one embodiment, sub-interest groups within one or more channels may be determined. These sub-interest groups may include a portion of a channel's users that exhibit at least similar interaction with a sub-interest of an interest of the channel. In at least one embodiment, a sub-interest group may include subscribed users that share a common sub-interest. In one non-limiting, non-exhaustive example, a channel for sports may be determined to include a sub-interest group with a sub-interest in United States breaking news (e.g., breaking news about sports in the United States). In another non-limiting, non-exhaustive example, a channel for politics and a channel for sports may include sub-interest groups with a sub-interest in United States breaking news. A new channel may be automatically generated for the sub-interest to generate a hierarchy of channels, where new content may be posted and/or provided to the new channel.

Users associated with the sub-interest groups and/or other users may be invited to subscribe to the new channel. In some embodiments, a user may be invited to subscribe to the new channel (i.e., the new channel may be proposed to the user) when the user accesses content on different channel. In at least one embodiment, in response to a user requesting content published by a channel, another channel may be determined based at least on a weighing of the other channel. In various embodiments, this other channel may be referred to as a proposed channel. The user may then be invited to subscribe to the other/proposed channel. For example, if a user accesses content on the sports channel, that user may be invited to subscribe to the United States breaking news channel. In at least one embodiment, the proposed channel may be determined based on a weight and/or value of channels associated with the content accessed by the user (i.e., channels with characteristics similar to features of the accessed content). Similarly, a proposed channel may be provided to a publisher for new content based on the weight and/or value of channels associated with the new content (i.e., channels with characteristics similar to features of the new content).

In some embodiments, channels may be discontinued if a value of the channel falls below a predetermined threshold (e.g., a value of user interactions for the channel). In other embodiments, channels with overlapping characteristics (e.g., a percentage of common users) may be merged together into one channel if the overlapping channels satisfy merging criteria. In at least one such embodiment, the users of the overlapping channels may be automatically subscribed to the merged channel.

### Illustrative Operating Environment

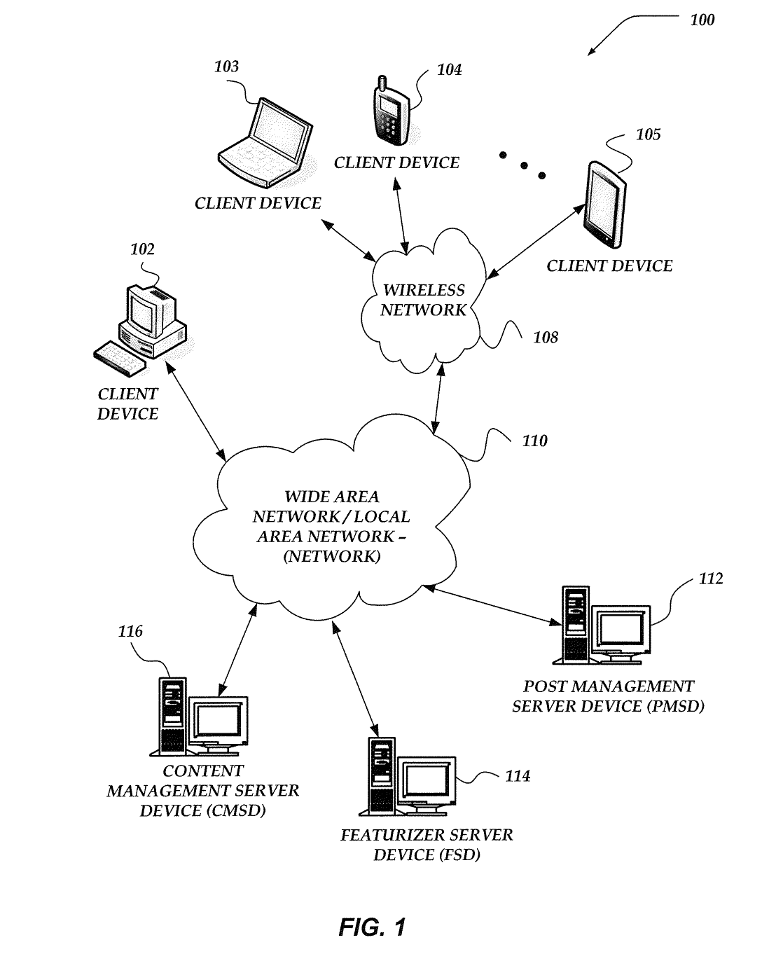

FIG. 1 shows components of one embodiment of an environment in which embodiments of the invention may be practiced. Not all of the components may be required to practice the invention, and variations in the arrangement and type of the components may be made without departing from the spirit or scope of the invention. As shown, system 100 of FIG. 1 includes local area networks (LANs)/wide area networks (WANs)—(network) 110, wireless network 108, client devices 102-105, Post Management Server Device (PMSD) 112, Featurizer Server Device (FSD) 114, and Content Management Server Device (CMSD) 116.

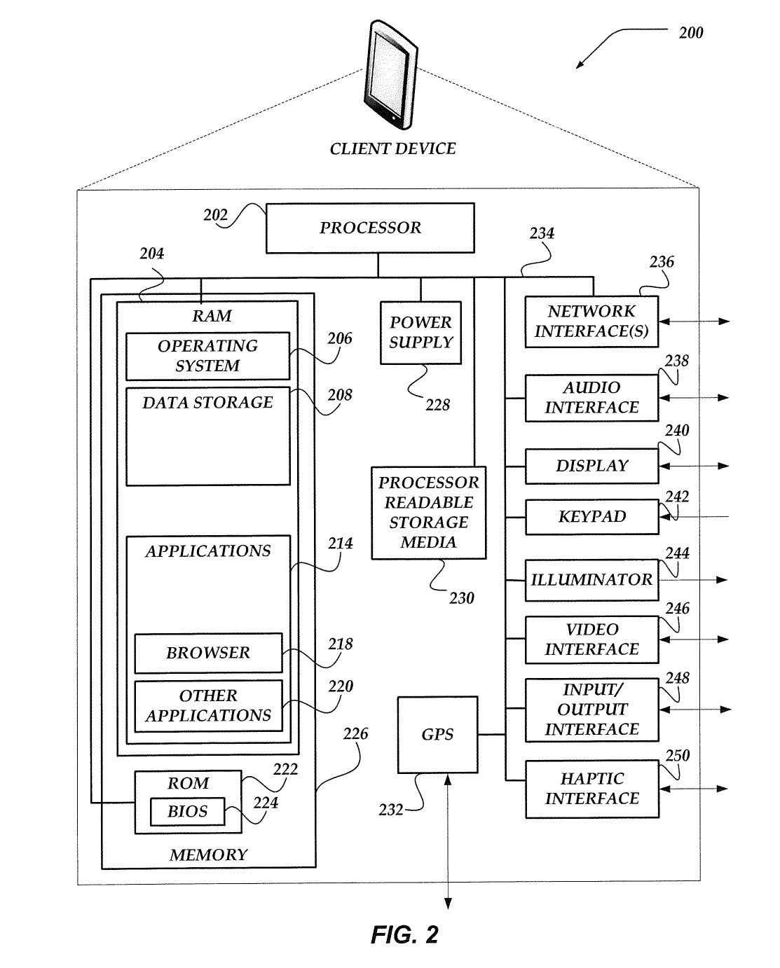

At least one embodiment of client devices 102-105 is described in more detail below in conjunction with FIG. 2. In one embodiment, at least some of client devices 102-105 may operate over a wired and/or wireless network, such as networks 110 and/or 108. Generally, client devices 102-105 may include virtually any computing device capable of communicating over a network to send and receive information, perform various online activities, offline actions, or the like. In one embodiment, one or more of client devices 102-105 may be configured to operate within a business or other entity to perform a variety of services for the business or other entity. For example, client devices 102-105 may be configured to operate as a web server, an accounting server, a production server, an inventory server, or the like. However, client devices 102-105 are not constrained to these services and may also be employed, for example, as an end-user computing node, in other embodiments. It should be recognized that more or less client devices may be included within a system such as described herein, and embodiments are therefore not constrained by the number or type of client devices employed.

Devices that may operate as client device 102 may include devices that typically connect using a wired or wireless communications medium such as personal computers, multiprocessor systems, microprocessor-based or programmable electronic devices, network PCs, or the like. In some embodiments, client devices 102-105 may include virtually any portable personal computing device capable of connecting to another computing device and receiving information such as, laptop computer 103, smart mobile telephone 104, and tablet computers 105, and the like. However, portable computing devices are not so limited and may also include other portable devices such as cellular telephones, display pagers, radio frequency (RF) devices, infrared (IR) devices, Personal Digital Assistants (PDAs), handheld computers, wearable computers, integrated devices combining one or more of the preceding devices, and the like. As such, client devices 102-105 typically range widely in terms of capabilities and features. Moreover, client devices 102-105 may access various computing applications, including a browser, or other web-based application.

A web-enabled client device may include a browser application that is configured to receive and to send web pages, web-based messages, and the like. The browser application may be configured to receive and display graphics, text, multimedia, and the like, employing virtually any web-based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SGML), HyperText Markup Language (HTML), eXtensible Markup Language (XML), and the like, to display and send a message. In one embodiment, a user of the client device may employ the browser application to perform various activities over a network (online). However, another application may also be used to perform various online activities.

Client devices 102-105 also may include at least one other client application that is configured to receive and/or send content between another computing device. The client application may include a capability to send and/or receive content, or the like. The client application may further provide information that identifies itself, including a type, capability, name, and the like. In one embodiment, client devices 102-105 may uniquely identify themselves through any of a variety of mechanisms, including an Internet Protocol (IP) address, a phone number, Mobile Identification Number (MIN), an electronic serial number (ESN), or other device identifier. Such information may be provided in a network packet, or the like, sent between other client devices, PMSD 112, FSD 114, CMSD 116, or other computing devices.

Client devices 102-105 may further be configured to include a client application that enables an end-user to log into an end-user account that may be managed by another computing device, such as CMSD 116, or the like. Such end-user account, in one non-limiting example, may be configured to enable the end-user to manage one or more online activities, including in one non-limiting example, search activities, social networking activities, browse various websites, communicate with other users, or the like. However, participation in such online activities may also be performed without logging into the end-user account.

Wireless network 108 is configured to couple client devices 103-105 and its components with network 110. Wireless network 108 may include any of a variety of wireless sub-networks that may further overlay stand-alone ad-hoc networks, and the like, to provide an infrastructure-oriented connection for client devices 103-105. Such sub-networks may include mesh networks, Wireless LAN (WLAN) networks, cellular networks, and the like. In one embodiment, the system may include more than one wireless network.

Wireless network 108 may further include an autonomous system of terminals, gateways, routers, and the like connected by wireless radio links, and the like. These connectors may be configured to move freely and randomly and organize themselves arbitrarily, such that the topology of wireless network 108 may change rapidly.

Wireless network 108 may further employ a plurality of access technologies including 2nd (2G), 3rd (3G), 4th (4G) 5th (5G) generation radio access for cellular systems, WLAN, Wireless Router (WR) mesh, and the like. Access technologies such as 2G, 3G, 4G, 5G, and future access networks may enable wide area coverage for mobile devices, such as client devices 103-105 with various degrees of mobility. In one non-limiting example, wireless network 108 may enable a radio connection through a radio network access such as Global System for Mobil communication (GSM), General Packet Radio Services (GPRS), Enhanced Data GSM Environment (EDGE), code division multiple access (CDMA), time division multiple access (TDMA), Wideband Code Division Multiple Access (WCDMA), High Speed Downlink Packet Access (HSDPA), Long Term Evolution (LTE), and the like. In essence, wireless network 108 may include virtually any wireless communication mechanism by which information may travel between client devices 103-105 and another computing device, network, and the like.

Network 110 is configured to couple network devices with other computing devices, including, PMSD 112, FSD 114, CMSD 116, client device 102, and client devices 103-105 through wireless network 108. Network 110 is enabled to employ any form of computer readable media for communicating information from one electronic device to another. Also, network 110 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. In addition, communication links within LANs typically include twisted wire pair or coaxial cable, while communication links between networks may utilize analog telephone lines, full or fractional dedicated digital lines including T1 , T2, T3, and T4, and/or other carrier mechanisms including, for example, E-carriers, Integrated Services Digital Networks (ISDNs), Digital Subscriber Lines (DSLs), wireless links including satellite links, or other communications links known to those skilled in the art. Moreover, communication links may further employ any of a variety of digital signaling technologies, including without limit, for example, DS-0, DS-1, DS-2, DS-3, DS-4, OC-3, OC-12, OC-48, or the like. Furthermore, remote computers and other related electronic devices could be remotely connected to either LANs or WANs via a modem and temporary telephone link. In one embodiment, network 110 may be configured to transport information of an Internet Protocol (IP). In essence, network 110 includes any communication method by which information may travel between computing devices.

Additionally, communication media typically embodies computer readable instructions, data structures, program modules, or other transport mechanism and includes any information delivery media. By way of example, communication media includes wired media such as twisted pair, coaxial cable, fiber optics, wave guides, and other wired media and wireless media such as acoustic, RF, infrared, and other wireless media.

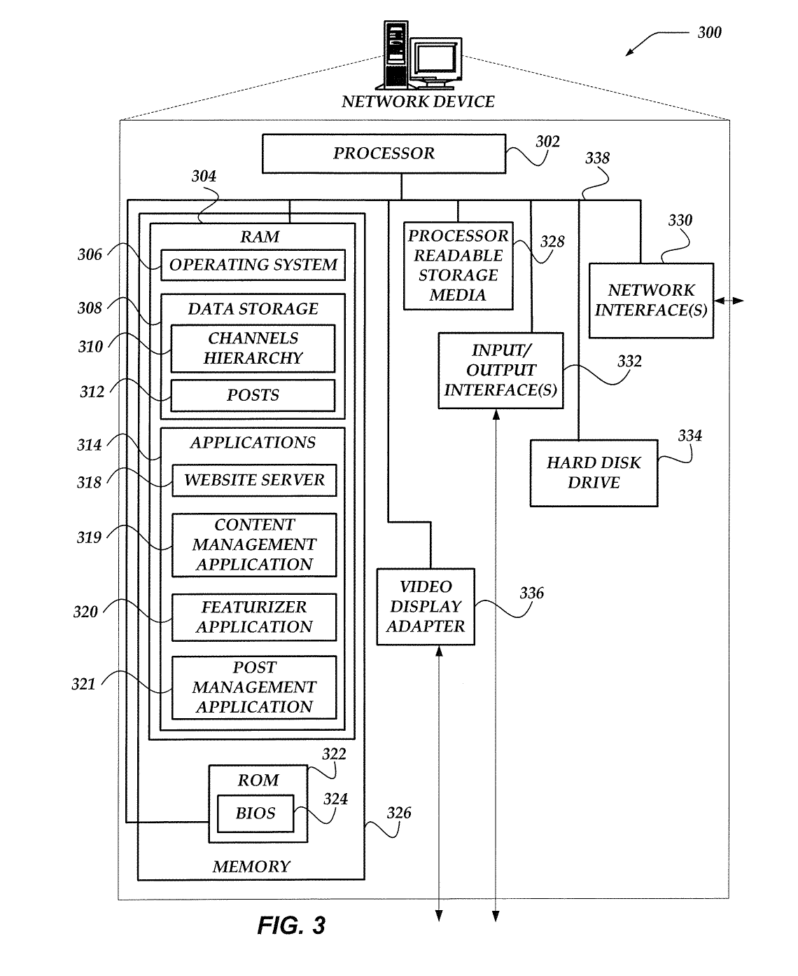

One embodiment of PMSD 112 is described in more detail below in conjunction with FIG. 3. Briefly, however, PMSD 112 includes virtually any network device capable of posting and/or otherwise providing content to a channel. In at least one embodiment, PMSD 112 may determine one or more possible channels to post content. In some embodiments, PMSD 112 may be enabled to provide the possible channels to a publisher for selecting which channels to post content. In some embodiments, PMSD 112 may monitor and/or track users' access of channels and/or content. PMSD 112 may, in some embodiments, be enabled to determine a subset of channels to post content to based characteristics of the channels and features of the content. PMSD 112 may be operative to communicate with other network devices, such as CMSD 116.

Devices that may be arranged to operate as PMSD 112 include various network devices, including, but not limited to personal computers, desktop computers, multiprocessor systems, microprocessor-based or programmable consumer electronics, network PCs, server devices, network appliances, and the like.

Although FIG. 1 illustrates PMSD 112 as a single computing device, the invention is not so limited. For example, one or more functions of the PMSD 112 may be distributed across one or more distinct network devices. Moreover, PMSD 112 is not limited to a particular configuration. Thus, in one embodiment, PMSD 112 may contain a plurality of network devices. In another embodiment, PMSD 112 may contain a plurality of network devices that operate using a master/slave approach, where one of the plurality of network devices of PMSD 112 operates to manage and/or otherwise coordinate operations of the other network devices. In other embodiments, the PMSD 112 may operate as a plurality of network devices within a cluster architecture, a peer-to-peer architecture, and/or even within a cloud architecture. Thus, the invention is not to be construed as being limited to a single environment, and other configurations, and architectures are also envisaged.

One embodiment of FSD 114 is described in more detail below in conjunction with FIG. 3. Briefly, however, FSD 114 includes virtually any network device capable of determining features of content. In at least one embodiment, FSD 114 may employ text recognition, image/video recognition, or the like, to determine the features of content. In another embodiments, FSD 112 may enable a publisher define, determine, and/or select the features. In some embodiments FSD 114 may be operative to communicate with CMSD 116 to access content and/or store features of content.

Devices that may be arranged to operate as FSD 114 include various network devices, including, but not limited to personal computers, desktop computers, multiprocessor systems, microprocessor-based or programmable consumer electronics, network PCs, server devices, network appliances, and the like.

Although FIG. 1 illustrates FSD 114 as a single computing device, the invention is not so limited. For example, one or more functions of the FSD 114 may be distributed across one or more distinct network devices. Moreover, FSD 114 is not limited to a particular configuration. Thus, in one embodiment, FSD 114 may contain a plurality of network devices. In another embodiment, FSD 114 may contain a plurality of network devices that operate using a master/slave approach, where one of the plurality of network devices of FSD 114 operates to manage and/or otherwise coordinate operations of the other network devices. In other embodiments, the FSD 114 may operate as a plurality of network devices within a cluster architecture, a peer-to-peer architecture, and/or even within a cloud architecture. Thus, the invention is not to be construed as being limited to a single environment, and other configurations, and architectures are also envisaged.

One embodiment of CMSD 116 is described in more detail below in conjunction with FIG. 3. Briefly, however, CMSD 116 includes virtually any network device capable of managing a plurality of content. In some embodiments, CMSD 116 may manage a hierarchy of channels. In some embodiments, CMSD 116 may determine sub-interests and/or sub-interest groups of one or more channels. CMSD 116 may be enabled to automatically generate one or more channels based on determined sub-interests. In some embodiments, CMSD 116 may be enabled to discontinue and/or merge channels.

Devices that may be arranged to operate as CMSD 116 include various network devices, including, but not limited to personal computers, desktop computers, multiprocessor systems, microprocessor-based or programmable consumer electronics, network PCs, server devices, network appliances, and the like.

Although FIG. 1 illustrates CMSD 116 as a single computing device, the invention is not so limited. For example, one or more functions of the CMSD 116 may be distributed across one or more distinct network devices. Moreover, CMSD 116 is not limited to a particular configuration. Thus, in one embodiment, CMSD 116 may contain a plurality of network devices. In another embodiment, CMSD 116 may contain a plurality of network devices that operate using a master/slave approach, where one of the plurality of network devices of CMSD 116 operates to manage and/or otherwise coordinate operations of the other network devices. In other embodiments, the CMSD 116 may operate as a plurality of network devices within a cluster architecture, a peer-to-peer architecture, and/or even within a cloud architecture. Thus, the invention is not to be construed as being limited to a single environment, and other configurations, and architectures are also envisaged.

### Illustrative Client Device

FIG. 2 shows one embodiment of client device 200 that may be included in a system implementing embodiments of the invention. Client device 200 may include many more or less components than those shown in FIG. 2. However, the components shown are sufficient to disclose an illustrative embodiment for practicing the present invention. Client device 200 may represent, for example, one embodiment of at least one of client devices 102-105 of FIG. 1.

As shown in the figure, client device 200 includes a processor 202 in communication with a mass memory 226 via a bus 234. In some embodiments, processor 202 may include one or more central processing units (CPU). Client device 200 also includes a power supply 228, one or more network interfaces 236, an audio interface 238, a display 240, a keypad 242, an illuminator 244, a video interface 246, an input/output interface 248, a haptic interface 250, and a global positioning system (GPS) receiver 232.

Power supply 228 provides power to client device 200. A rechargeable or non-rechargeable battery may be used to provide power. The power may also be provided by an external power source, such as an alternating current (AC) adapter or a powered docking cradle that supplements and/or recharges a battery.

Client device 200 may optionally communicate with a base station (not shown), or directly with another computing device. Network interface 236 includes circuitry for coupling client device 200 to one or more networks, and is constructed for use with one or more communication protocols and technologies including, but not limited to, GSM, CDMA, TDMA, GPRS, EDGE, WCDMA, HSDPA, LTE, user datagram protocol (UDP), transmission control protocol/Internet protocol (TCP/IP), short message service (SMS), WAP, ultra wide band (UWB), IEEE 802.16 Worldwide Interoperability for Microwave Access (WiMax), session initiated protocol/real-time transport protocol (SIP/RTP), or any of a variety of other wireless communication protocols. Network interface 236 is sometimes known as a transceiver, transceiving device, or network interface card (NIC).

Audio interface 238 is arranged to produce and receive audio signals such as the sound of a human voice. For example, audio interface 238 may be coupled to a speaker and microphone (not shown) to enable telecommunication with others and/or generate an audio acknowledgement for some action.

Display 240 may be a liquid crystal display (LCD), gas plasma, light emitting diode (LED), organic LED, or any other type of display used with a computing device. Display 240 may also include a touch sensitive screen arranged to receive input from an object such as a stylus or a digit from a human hand.

Keypad 242 may comprise any input device arranged to receive input from a user. For example, keypad 242 may include a push button numeric dial, or a keyboard. Keypad 242 may also include command buttons that are associated with selecting and sending images.

Illuminator 244 may provide a status indication and/or provide light. Illuminator 244 may remain active for specific periods of time or in response to events. For example, when illuminator 244 is active, it may backlight the buttons on keypad 242 and stay on while the client device is powered. Also, illuminator 244 may backlight these buttons in various patterns when particular actions are performed, such as dialing another client device. Illuminator 244 may also cause light sources positioned within a transparent or translucent case of the client device to illuminate in response to actions.

Video interface 246 is arranged to capture video images, such as a still photo, a video segment, an infrared video, or the like. For example, video interface 246 may be coupled to a digital video camera, a web-camera, or the like. Video interface 246 may comprise a lens, an image sensor, and other electronics. Image sensors may include a complementary metal-oxide-semiconductor (CMOS) integrated circuit, charge-coupled device (CCD), or any other integrated circuit for sensing light.

Client device 200 also comprises input/output interface 248 for communicating with external devices, such as a headset, or other input or output devices not shown in FIG. 2. Input/output interface 248 can utilize one or more communication technologies, such as USB, infrared, Bluetooth™, or the like.

Haptic interface 250 is arranged to provide tactile feedback to a user of the client device. For example, the haptic interface 250 may be employed to vibrate client device 200 in a particular way when another user of a computing device is calling. In some embodiments, haptic interface 250 may be optional.

Client device 200 may also include GPS transceiver 232 to determine the physical coordinates of client device 200 on the surface of the Earth. GPS transceiver 232, in some embodiments, may be optional. GPS transceiver 232 typically outputs a location as latitude and longitude values. However, GPS transceiver 232 can also employ other geo-positioning mechanisms, including, but not limited to, triangulation, assisted GPS (AGPS), Enhanced Observed Time Difference (E-OTD), Cell Identifier (CI), Service Area Identifier (SAT), Enhanced Timing Advance (ETA), Base Station Subsystem (BSS), or the like, to further determine the physical location of client device 200 on the surface of the Earth. It is understood that under different conditions, GPS transceiver 232 can determine a physical location within millimeters for client device 200; and in other cases, the determined physical location may be less precise, such as within a meter or significantly greater distances. In one embodiment, however, mobile device 200 may through other components, provide other information that may be employed to determine a physical location of the device, including for example, a Media Access Control (MAC) address, IP address, or the like.

Mass memory 226 includes a Random Access Memory (RAM) 204, a Read-only Memory (ROM) 222, and other storage means. Mass memory 226 illustrates an example of computer readable storage media (devices) for storage of information such as computer readable instructions, data structures, program modules or other data. Mass memory 226 stores a basic input/output system (BIOS) 224 for controlling low-level operation of client device 200. The mass memory also stores an operating system 206 for controlling the operation of client device 200. It will be appreciated that this component may include a general-purpose operating system such as a version of UNIX, or LINUX™, or a specialized client communication operating system such as Microsoft Corporation's Windows Mobile™, Apple Corporation's iOS™, Google Corporation's Android™ or the Symbian® operating system. The operating system may include, or interface with a Java virtual machine module that enables control of hardware components and/or operating system operations via Java application programs.

Mass memory 226 further includes one or more data storage 208, which can be utilized by client device 200 to store, among other things, applications 214 and/or other data. For example, data storage 208 may also be employed to store information that describes various capabilities of client device 200. The information may then be provided to another device based on any of a variety of events, including being sent as part of a header during a communication, sent upon request, or the like. Data storage 208 may also be employed to store social networking information including address books, buddy lists, aliases, user profile information, or the like. Further, data storage 208 may also store message, we page content, or any of a variety of user generated content. At least a portion of the information may also be stored on another component of network device 200, including, but not limited to processor readable storage media 230, a disk drive or other computer readable storage devices (not shown) within client device 200.

Processor readable storage media 230 may include volatile, nonvolatile, removable, and non-removable media implemented in any method or technology for storage of information, such as computer- or processor-readable instructions, data structures, program modules, or other data. Examples of computer readable storage media include RAM, ROM, Electrically Erasable Programmable Read-only Memory (EEPROM), flash memory or other memory technology, Compact Disc Read-only Memory (CD-ROM), digital versatile disks (DVD) or other optical storage, magnetic cassettes, magnetic tape, magnetic disk storage or other magnetic storage devices, or any other physical medium which can be used to store the desired information and which can be accessed by a computing device. Processor readable storage media 230 may also be referred to herein as computer readable storage media and/or computer readable storage device.

Applications 214 may include computer executable instructions which, when executed by client device 200, transmit, receive, and/or otherwise process network data. Network data may include, but is not limited to, messages (e.g. SMS, Multimedia Message Service (MMS), instant message (IM), email, and/or other messages), audio, video, and enable telecommunication with another user of another client device. Applications 214 may include, for example, browser 218, and other applications 220. Other applications 220 may include, but are not limited to, calendars, search programs, email clients, IM applications, SMS applications, voice over Internet Protocol (VOIP) applications, contact managers, task managers, transcoders, database programs, word processing programs, security applications, spreadsheet programs, games, search programs, and so forth.

Browser 218 may include virtually any application configured to receive and display graphics, text, multimedia, messages, other content, and the like, employing virtually any web based language. In one embodiment, the browser application is enabled to employ HDML, WML, WMLScript, JavaScript, SGML, HTML, XML, and the like, to display and send a message. However, any of a variety of other web-based programming languages may be employed. In one embodiment, browser 218 may enable a user of client device 200 to communicate with another network device, such as PMSD 112, FSD 114, and/or CMSD 116 of FIG. 1.

### Illustrative Network Device

FIG. 3 shows one embodiment of a network device 300, according to one embodiment of the invention. Network device 300 may include many more or less components than those shown. The components shown, however, are sufficient to disclose an illustrative embodiment for practicing the invention. Network device 300 may be configured to operate as a server, client, peer, a host, or any other device. Network device 300 may represent, for example PMSD 112, FSD 114, CMSD 116 of FIG. 1, and/or other network devices.

Network device 300 includes processor 302, processor readable storage media 328, network interface unit 330, an input/output interface 332, hard disk drive 334, video display adapter 336, and memory 326, all in communication with each other via bus 338. In some embodiments, processor 302 may include one or more central processing units.

As illustrated in FIG. 3, network device 300 also can communicate with the Internet, or some other communications network, via network interface unit 330, which is constructed for use with various communication protocols including the TCP/IP protocol. Network interface unit 330 is sometimes known as a transceiver, transceiving device, or network interface card (NIC).

Network device 300 also comprises input/output interface 332 for communicating with external devices, such as a keyboard, or other input or output devices not shown in FIG. 3. Input/output interface 332 can utilize one or more communication technologies, such as USB, infrared, Bluetooth™, or the like.

Memory 326 generally includes RAM 304, ROM 322 and one or more permanent mass storage devices, such as hard disk drive 334, tape drive, optical drive, and/or floppy disk drive. Memory 326 stores operating system 306 for controlling the operation of network device 300. Any general-purpose operating system may be employed. Basic input/output system (BIOS) 324 is also provided for controlling the low-level operation of network device 300.

Although illustrated separately, memory 326 may include processor readable storage media 328. Processor readable storage media 328 may be referred to and/or include computer readable media, computer readable storage media, and/or processor readable storage device. Processor readable storage media 328 may include volatile, nonvolatile, removable, and non-removable media implemented in any method or technology for storage of information, such as computer readable instructions, data structures, program modules, or other data. Examples of processor readable storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other media which can be used to store the desired information and which can be accessed by a computing device.

Memory 326 further includes one or more data storage 308, which can be utilized by network device 300 to store, among other things, applications 314 and/or other data. For example, data storage 308 may also be employed to store information that describes various capabilities of network device 300. The information may then be provided to another device based on any of a variety of events, including being sent as part of a header during a communication, sent upon request, or the like. Data storage 308 may also be employed to store messages, web page content, or the like. At least a portion of the information may also be stored on another component of network device 300, including, but not limited to processor readable storage media 328, hard disk drive 334, or other computer readable storage medias (not shown) within client device 300.

Data storage 308 may include a database, text, spreadsheet, folder, file, or the like, that may be configured to maintain and store user account identifiers, user profiles, email addresses, IM addresses, and/or other network addresses; or the like. Data storage 308 may further include program code, data, algorithms, and the like, for use by a processor, such as processor 302 to execute and perform actions. In one embodiment, at least some of data store 308 might also be stored on another component of network device 300, including, but not limited to processor-readable storage media 328, hard disk drive 334, or the like.

Data store 308 may also include channels hierarchy 310 and/or posts 312. Channels hierarchy 310 may include a hierarchical structure of channels. In some embodiments, hierarchy 310 may maintain parent-child relationships between channels. In some embodiments, channels hierarchy 310 may include a list of users subscribed to each channel. Posts 312 may include one or more posts of content provided to a channel. In some embodiments, posts 312 may include a plurality of content.

Applications 314 may include computer executable instructions, which may be loaded into mass memory and run on operating system 306. Examples of application programs may include transcoders, schedulers, calendars, database programs, word processing programs, Hypertext Transfer Protocol (HTTP) programs, customizable user interface programs, IPSec applications, encryption programs, security programs, SMS message servers, IM message servers, email servers, account managers, and so forth. Applications 314 may also include website server 318, Content Management Application (CMA) 319, Featurizer Application 320, and Post Management Application (PMA) 321.

Website server 318 may represents any of a variety of information and services that are configured to provide content, including messages, over a network to another computing device. Thus, website server 318 can include, for example, a web server, a File Transfer Protocol (FTP) server, a database server, a content server, or the like. Website server 318 may provide the content including messages over the network using any of a variety of formats including, but not limited to WAP, HDML, WML, SGML, HTML, XML, Compact HTML (cHTML), Extensible HTML (xHTML), or the like.

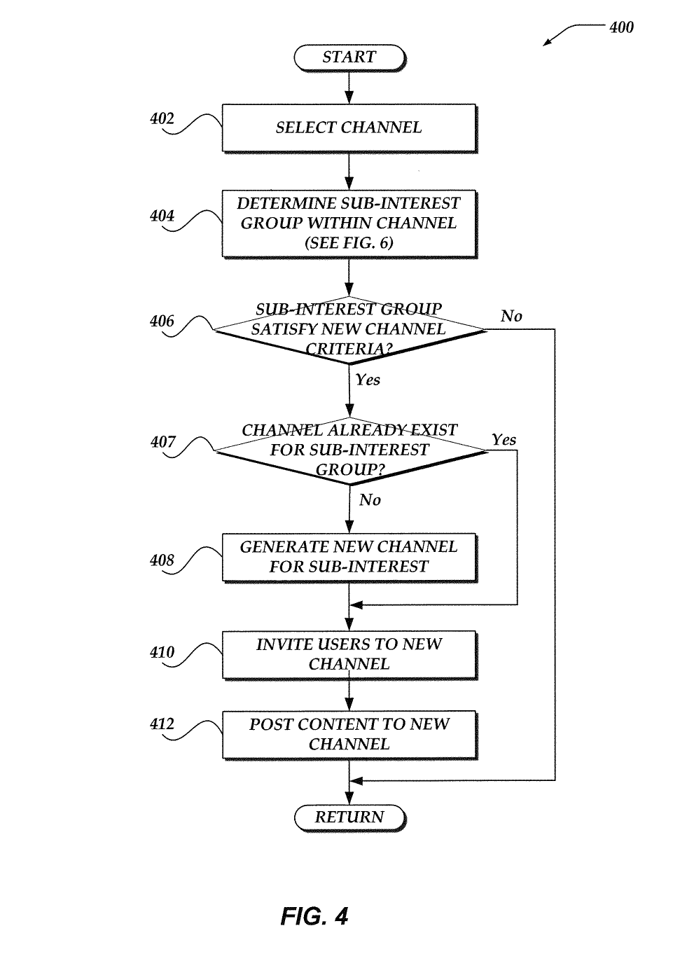

CMA 319 may be configured to manage a plurality of content and a hierarchy of channels, as described above in conjunction with CMSD 116 of FIG. 1. In some embodiments, CMA 319 may be employed by CMSD 116 of FIG. 1. In any event, CMA 319 may employ processes, or parts of processes, similar to those described in conjunction with FIGS. 4-12, to perform at least some of its actions.

Featurizer Application 320 may be configured to determine one or more features of each piece of content, as described above in conjunction with FSD 114 of FIG. 1. In some embodiments, Featurizer Application 320 may be employed by FSD 114 of FIG. 1. In any event, Featurizer Application 320 may employ processes, or parts of processes, similar to those described in conjunction with FIGS. 4-12, to perform at least some of its actions.

PMA 321 may be configured to manage a plurality of posts and to determine which channels to post content, as described above in conjunction with PMSD 112 of FIG. 1. In some embodiments, PMA 321 may be employed by PMSD 112 of FIG. 1. In any event, PMA 321 may employ processes, or parts of processes, similar to those described in conjunction with FIGS. 4-12, to perform at least some of its actions.

### General Operation

The operation of certain aspects of the invention will now be described with respect to FIGS. 4-12. FIG. 4 illustrates a logical flow diagram generally showing one embodiment of an overview process for generating a new channel for a sub-interest of a channel. In some embodiments, process 400 of FIG. 4 may be implemented by and/or executed on a single network device, such as network device 300 of FIG. 3. In other embodiments, process 400 or portions of process 400 of FIG. 4 may be implemented by and/or executed on a plurality of network devices, such as network device 300 of FIG. 3.

Process 400 begins, after a start block, at block 402, where a channel may be selected. In some embodiments, process 400 may be performed for each of a plurality of channels. Each channel may be selected at predetermined time intervals, randomly, based on a selection threshold, based on an event, or the like, or any combination thereof. In some embodiments, a selection threshold may be a number of users of a channel, a number of clicks on one or more pieces of related content (e.g., content with the same or similar features), or the like. In other embodiments, a publisher may manually select a channel, such as, for example, if the publisher determines that the channel may include a group of users that may benefit from a new channel for a sub-interest.

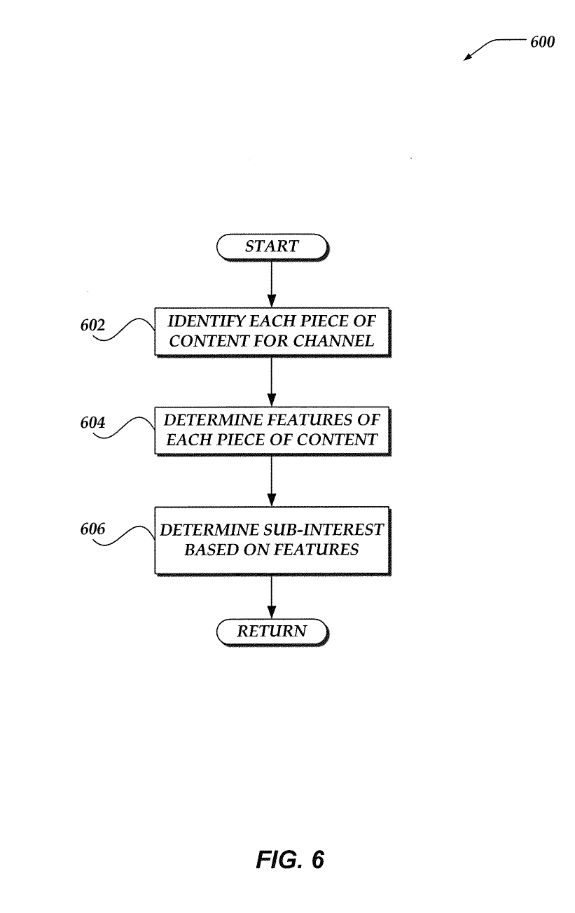

Process 400 proceeds to block 404, which is described in more detail below in conjunction with FIG. 6. Briefly, however, at block 404 a sub-interest group within the selected channel may be determined. In some embodiments, one or more sub-interest groups may be determined. In at least one embodiment, a sub-interest group may be one or more users that subscriber to a channel that exhibit at least similar interaction in related content. In some embodiments, users may exhibit at least similar interactions in content by performing an action on the content, such as, for example, accessing, viewing, clicking on, posting comments, sharing, and/or otherwise interacting with the content. The related content may be referred to as a sub-interest of an interest of the channel (or, in other embodiments, as a sub-category of a category of the channel). In at least one embodiment, a sub-interest of a channel may be one or more pieces of content that share one or more common features. As described above, features may include, for example, a subject, topic, and/or theme of the content; a trend, character, and/or person associated with the content; a keyword included in the content; a date of creation; an author, publisher, and/or poster of the content; or the like.

In any event, process 400 continues at decision block 406, where a determination may be made whether the sub-interest group satisfies at least one new channel criteria. In some embodiments, the new channel criteria may be based on a threshold number of users. For example, if a sub-interest group includes a number of users above a threshold (e.g., 1000 users), then the new channel criteria may be affirmatively satisfied. In other embodiments, the new channel criteria may be based on a number of actions performed on the content associated with the sub-interest (e.g., 1000 views of a piece of content). In some other embodiments, the new channel criteria may be satisfied if a threshold number of users each access a threshold number of different pieces of content associated with the sub-interest. However, embodiments are not so limited and other new channel criteria may be employed. If the sub-interest group satisfies the new channel criteria, then process 400 may flow to decision block 407; otherwise, process 400 may return to a calling process to perform other actions.

At decision block 407, a determination may be made whether a channel already exists for the sub-interest group. In at least one embodiment, such a determination may be performed by comparing the sub-interest with characteristics of other and/or previously-generated channels. In another embodiment, this determination may be performed by comparing the users of the sub-interest group with users of other channels. If a channel already exists, then process 400 may flow to block 410; otherwise, process 400 may flow to block 408.

At block 408, a new channel may be generated. In at least one embodiment, generating a new channel may include initializing a social networking page (e.g., signing up, registering, and/or otherwise initiating an account with social networking website), creating a new environment within a social network (e.g., a page, handle, site, or the like), creating a mailing list of users for the sub-interest, or the like. However, embodiments are not so limited and other mechanisms may be employed to generate a new channel In some embodiments, the content from the channel that is associated with the sub-interest may be automatically provided to the new channel. In some embodiments, the new channel may be linked to the selected channel, such that a hierarchy of channels is formed where the selected channel may be a parent channel and the new channel may be a child channel.

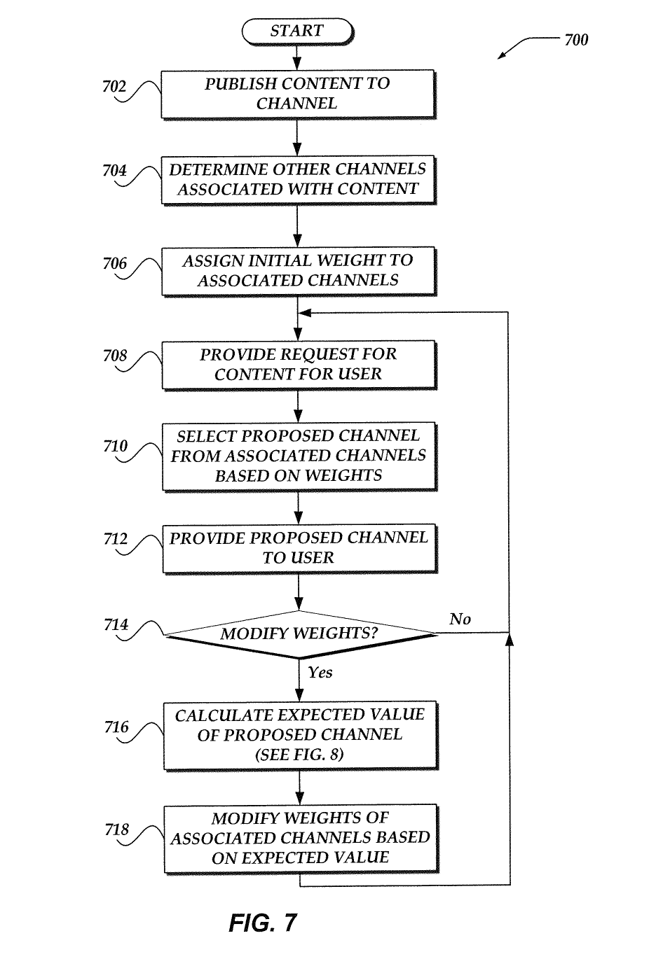

Process 400 proceeds next to block 410, where users may be invited to the new channel. Inviting a user to the new channel may include sending and/or otherwise presenting a message to the user requesting the user to access, signup, and/or otherwise subscribe to the new channel. In other embodiments, inviting users to a new channel may include adding users to a mailing list associated with the new channel. In some embodiments, the users associated with the sub-interest group may be invited to the new channel. In other embodiments, users that later access content posted to a channel (e.g., the new channel) may be invited to the new channel. Such an embodiment is described in more detail below in conjunction with FIG. 7, where the new channel may be a proposed channel provided to a user.

In some embodiments, where a channel already exists for the sub-interest, such as determined at decision block 407, users associated with the sub-interest group may be invited to the already existing channel.

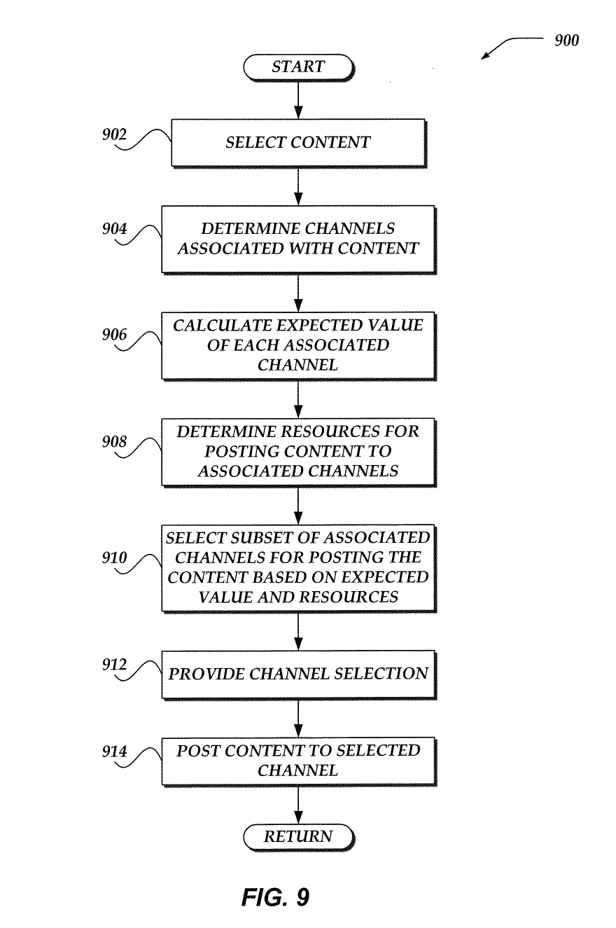

Process 400 continues at block 412, where content may be posted, published, and/or otherwise provided to the new channel. In some embodiments, the content associated with the sub-interest may be automatically posted and/or added to the new channel. In other embodiments, the new channel may be selected to post later created content. Such an embodiment is described in more detail below in conjunction with FIG. 9, where the new channel may be selected for posting content. In some other embodiments, posting content to the new channel may also include automatically posting the content to at least one parent channel of the new channel. In at least one embodiment, the content provided to a channel may be optimized based on interests of users associated with the channel.

After block 412, process 400 may return to a calling process to perform other actions.

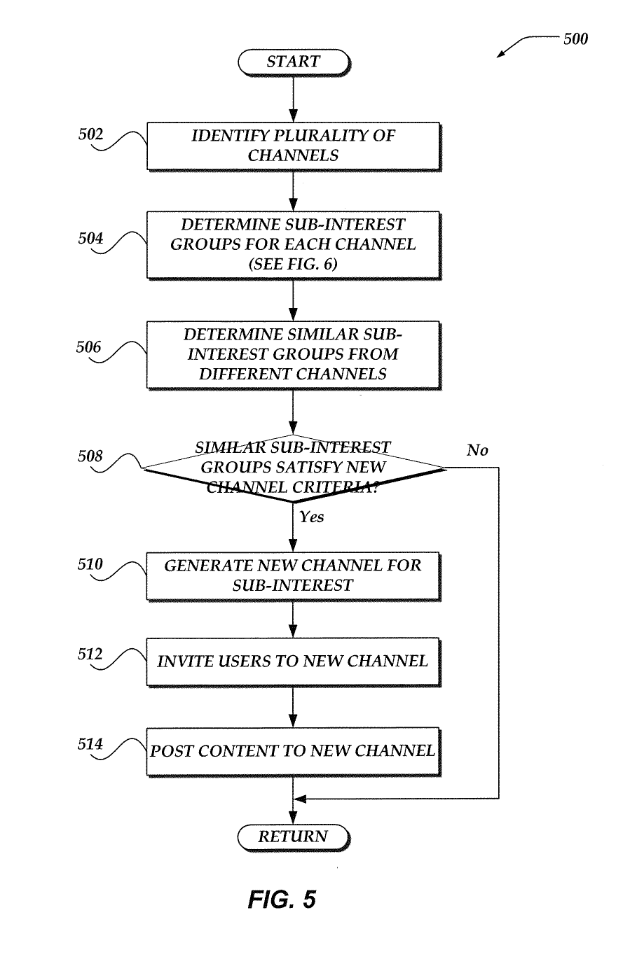

FIG. 5 illustrates a logical flow diagram generally showing one embodiment of a process for generating a new channel for a similar sub-interest common to multiple channels. In some embodiments, process 500 of FIG. 5 may be implemented by and/or executed on a single network device, such as network device 300 of FIG. 3. In other embodiments, process 500 or portions of process 500 of FIG. 5 may be implemented by and/or executed on a plurality of network devices, such as network device 300 of FIG. 3.

Process 500 begins, after a start block, at block 502, where a plurality of channels may be identified. In at least one embodiment, block 502 may employ embodiments of block 402 of FIG. 4 to identify one or more of the plurality of channels.

Process 500 proceeds to block 504, where one or more sub-interest groups for each of the plurality of identified channels may be determined. In at least one embodiment, block 504 may employ embodiments of block 404 of FIG. 4 to determine sub-interest groups for each channel.

Process 500 continues at block 506, where similar sub-interest groups from different channels may be determined. In some embodiments, two or more sub-interest groups may be similar sub-interest groups if at least a subset of users associated with the sub-interest groups are the same users. In other embodiments, sub-interest groups may be similar if the corresponding sub-interests are related. In at least one of various embodiments, sub-interest may be related if at least a subset of the content associated with the sub-interests include one or more common features. For example, two sub-interest groups may be similar if both sub-interest groups access content created by a specific entity (e.g., a same author common to multiple articles associated with both sub-interest groups). In some embodiments, one or more clustering and/or comparison algorithms and/or techniques may be employed to determining similar sub-interest groups.

In any event, process 500 proceeds next to decision block 508, where a determination may be made whether the similar sub-interest groups satisfy new channel criteria. In at least one embodiment, decision block 508 may employ embodiments of decision block 406 to determine if a sub-interest group satisfies the new channel criteria. For example, in some embodiments, the new channel criteria may be based on a threshold number of users that are common to the similar sub-interest groups. In other embodiments, the new channel criteria may be based on a number of actions performed on the content associated with the similar sub-interests. However, embodiments are not so limited and other new channel criteria may be employed. If the similar sub-interest groups satisfy the new channel criteria, then process 500 may flow to block 510; otherwise, process 500 may return to a calling process to perform other actions.

At block 510, a new channel for the similar sub-interest groups may be generated. In at least one embodiment, block 510 may employ embodiments of block 408 of FIG. 4 to generate a new channel. In some embodiments, the new channel may be linked to the channels with the similar sub-interest groups, such that a hierarchy of channels is formed where the channels with the similar sub-interest groups may be a parent channels and the new channel may be a child channel.

Process 500 proceeds next to block 512, where users may be invited to the new channel. In at least one of various embodiments, block 512 may employ embodiments of block 410 of FIG. 4 to invite users to the new channel.

In any event, process 500 continues at block 514, where content may be posted to the new channel. In some embodiments, block 514 may employ embodiments of block 412 of FIG. 4 to post content to the new channel.

After block 512, process 500 may return to a calling process to perform other actions.

FIG. 6 illustrates a logical flow diagram generally showing one embodiment of a process for determining a sub-interest group of a channel. In some embodiments, process 600 of FIG. 6 may be implemented by and/or executed on a single network device, such as network device 300 of FIG. 3. In other embodiments, process 600 or portions of process 600 of FIG. 6 may be implemented by and/or executed on a plurality of network devices, such as network device 300 of FIG. 3.

Process 600 begins, after a start block, at block 602, where each piece of content for a channel may be identified. In some embodiments, content of a channel may include all or a subset of all the content that was provided to one or more users through the channel. For example, each post to a social media page may be identified.

Process 600 proceeds to block 604, where features of each piece of content may be determined As noted above, features may include, but are not limited to, a subject and/or topic of the content, keywords associated with the content, a date of creation, author, publisher/poster, names of people discussed/included in the content, or the like. In some embodiments, metadata of the content may include the features associated with that piece of content. In other embodiments, a table or other data structure may maintain a record of each piece of content associated with a channel and the corresponding features. In yet other embodiments, traffic achieved for each piece of content on each channel may be monitored and stored.

Continuing next to block 606, at least one sub-interest may be determined based on the features. In at least one embodiment, one or more clustering algorithms may be employed to determine the sub-interest. In some embodiments, the sub-interest may be based on one or more common features among a plurality of pieces of content. For example, one sub-interest may include all content with the feature “sports” and another sub-interest group may be “United States economy.” It should be recognized that, in some embodiments, content may be associated with one or more sub-interests. In at least one embodiment, each user associated with a sub-interest may also be determined to identify the sub-interest group (e.g., users that clicked on content, commented about content, or the like).

After block 606, process 600 may return to a calling process to perform in other actions.

FIG. 7 illustrates a logical flow diagram generally showing one embodiment of a process for managing and providing a proposed channel to a user. In some embodiments, process 700 of FIG. 7 may be implemented by and/or executed on a single network device, such as network device 300 of FIG. 3. In other embodiments, process 700 or portions of process 700 of FIG. 7 may be implemented by and/or executed on a plurality of network devices, such as network device 300 of FIG. 3.

Process 700 begins, after a start block, at block 702, where a piece of content may be posted, published, and/or otherwise provided to a channel, which may be referred to as the publishing channel. In at least one embodiment, process 700 may be employed for each of a plurality of content that may be provided to a user through a channel.

In at least one embodiment, the published content may be selected by a publisher, editor, audience development staff, marketing team, or the like. In some embodiments, the content may be selected from a plurality of different possible content that may be provided to a user (also referred to herein as a reader). For example, a plurality of possible content may include, but is not limited to, “today's top stories,” content regarding breaking news, most popular content among readers, editorially-curated content of special importance, randomly selected content, or the like.

In at least one embodiment, selecting content and/or creating content may include a featurization process. In some embodiments, this process may include determining one or more features of the content, such as described above in conjunction with block 604 of FIG. 6.

Process 700 continues at block 704, where one or more other channels associated with the content may be determined. Associated channels may be determined in a plurality of different ways, including, but not limited to, based on the published content, based on the channels themselves, or the like, or any combination thereof.

In at least one embodiment, the associated channels may be determined based on features of the selected content. In at least one embodiment, each channel may include one or more characteristics about a corresponding channel. In some embodiments, the characteristics may describe the content associated with a channel. For example, a channel may be characterized as “United States economy”, which may indicate that a majority of the content posted to the channel include the feature “United States economy.” In at least one of various embodiments, the features of the selected content may be compared to the characteristics of a channel to determine if a channel is associated with the selected content. Channels that include the same characteristic as a feature of the selected content may be determined to be associated with the selected content. In some embodiments, the characteristics of a channel may include one or more sub-interests.

In another embodiment, the associated channels may be determined based on characteristics of the channels themselves, independent of the content of the channels. As noted above, each channel may include one or more characteristics about a corresponding channel. In some embodiments, these characteristics may also describe an owner and/or host of the channel, users subscribed to the channel, users visiting the channel, demographics of users associated with the channel, advertised products and/or services on the channel, business that provide advertising to the channel, or the like. In at least one of various embodiments, the characteristics of the publishing channel may be compared to the characteristics of other channels to determine if at least one of the other channels is associated with the selected content. Channels that have the same characteristic as the characteristics of the publishing channel may be determined to be associated with the selected content.

Process 700 proceeds to block 706, where the associated channels may be assigned an initial weight. In some embodiments, each associated channel may be initially assigned an equal weight. For example, the weight of each associated channel may be initially assigned to 5 on a scale of 1-10. In other embodiments, the initial weight of each associated channel may be based on historical data associated with content and/or channels. Different embodiments for determined the weight of a channel is described in more detail below. In some embodiments, these weights may change over time as new content is published to channels, as previously published content is cross promoted between channels, as users access the channels and/or content, or the like, or any combination thereof.

The weights of channels may be determined based on the content published to the channels, characteristics of the channels, second order effects of content on different channels, combined weight of channel and content, or the like, or any combination thereof.

In some embodiments, the weight of an associated channel may be determined based on content. In at least one embodiment, features of the published content may be compared to characteristics of the associated channels (e.g., features of previously published content on the associated channels). Channels with characteristics that are the same or similar to features of the published content may be assigned a higher weight than channels with characteristics dissimilar to features of the published content. In at least one of various embodiments, similarity of channel characteristics/content features may be determined by matching identifiers of each channel characteristics with identifiers of content features. In at least one such embodiments, the more matches of identifiers between a channel and the published content, the higher the weight of that channel.

In other embodiments, the weight may be determined based on the channels themselves. In at least one embodiment, characteristics of the publishing channel may be compared to characteristics of the associated channels. Channels with characteristics that are the same or similar to the characteristics of the publishing channel may be assigned a higher weight than channels with characteristics dissimilar to the characteristics of the publishing channel. In at least one of various embodiments, similarity of channel characteristics may be determined by matching identifiers of channel characteristics of one channel with those of another channel. In at least one such embodiments, the more matches of identifiers between a channel and the publishing channel, the higher the weight of that channel.

In some other embodiments, the weight may be determined based on second order effects of publishing same content on different channels. In at least one embodiment, the second order effect may be determined by comparing a successfulness of content published on the publishing channel with a successfulness the same content published on one or more associated channels. Successfulness can be determined based on a number of clicks on the content, user engagement with the content (e.g., how long did users access the content, how many users shared the content, how many users commented on the content), a number of advertisement impressions associated with the content, a number of advertisements clicked on while the content is being accessed, or the like, or any combination thereof. However, embodiments are not so limited and other methods for determining successfulness of content on a channel may be employed.

In at least one embodiment, the weight of an associated channel may be determined based on an average of the successfulness of content published on the publishing channel and the successfulness the same content published the associated channel, such that the higher the average, the higher the weight.

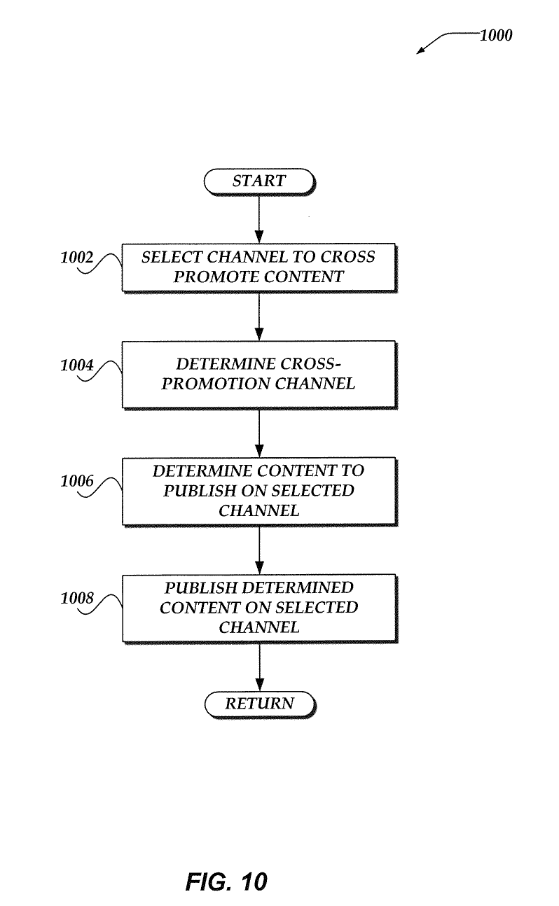

In yet other embodiments, the weight may be determined based on a combined weight of channel and content, which is described in more detail below in conjunction with FIG. 10. Briefly, however, a weight of a channel may be determined based on a combination of a total weight of the associated channel with a total weight of a content feature of the published content.

In at least one of various embodiments, each associated channel may include a plurality of weights, where each of the plurality of weights may be associated with a different type of content (i.e., a different content feature) (which may be referred to as a content weight). For example, the “United States economy” channel may have a content weight of 7 for content with feature “X,” but a 3 for content with feature “Y.”. In comparison, the “sports” channel may have a content weight of 8 for content with feature “Y,” but a 2 for content with feature “X.” In at least one of various embodiments, a total weight of a channel (i.e. a total channel weight) may be an average of the content weight of each content feature for that channel.

In other embodiments, each channel may include separate and/or different a plurality of weights that each correspond to a different publishing channel (e.g., each weight for a given channel may correspond to different relationships between the given channel and other channels) (which may be referred to as a publishing channel weight). For example, the “Washington State News” channel may have a channel weight of 8 where the publishing channel is the “United States News” channel, but may have a channel weight of 2 where the publishing channel is the “Atlantic Ocean Weather” channel. These different weights may indicate that content published on “Washington State News” channel has a higher success when re-published to the “United States News” channel, but a lower success when re-published to the “Atlantic Ocean Weather” channel. In at least one of various embodiments, a total weight of a content feature (i.e. a total feature weight) may be an average of the channel weight of each channel for that content feature.

In at least one of various embodiments, the total weights may be scaled based on a number of content published on a channel and/or with a content feature. Such scaling may include a multiplier based on the number of content published on a channel compared to a number of content published with a content feature.

In at least one embodiment, the weighting of a channel may be based on a combination of the above described embodiments. However, the above described embodiments for determining a weighting of a channel are not to be construed as exhaustive or limiting; but rather, other embodiments, algorithms, and/or mechanisms may be employed to determine weightings of channels.

In some embodiments, blocks 702, 704, and 706 may be performed when content is initially created and/or posted to a channel, and blocks 708, 710, 712, 716, and 718 may be continuously performed as long as (or for a predetermined period of time) the content is published to a channel.

Process 700 continues next at block 708, where a request for the content for a user may be provided. In some embodiments, the user may request the content such as, by clicking on the content, clicking on a link to the content, or the like. In some embodiments, a user may request content from one channel, but be provided a different proposed channel at block 712.

In any event, proceeding to block 710, a proposed channel from the channels associated with the content may be selected based on the weights of the associated channels. In at least one embodiment, the proposed channel may be randomly selected from the associated channels based on the weights. In some embodiments, an associated channel with a higher weight may be selected more often than an associated channel with a lower weight. In some embodiments, the proposed channel may include a channel that is not associated with the content, which may enable the system to explore additional channels unrelated to the content.

Process 700 proceeds next to block 712, where the proposed channel may be provided to the user. In at least one embodiment, the proposed channel may be provided to the user so that the user may be enabled to subscribe/opt in to the channel (e.g., sign up for or register for the channel). In some embodiments, a subset of the content may be provided to the user and the remainder of the content may be restricted from the user unless the user subscribers to the channel. If the user subscribes to the channel then the entire piece of content may be provided to the user.

In any event, process 700 continues at decision block 714, where a determination may be made whether or not to modify the weights of the associated channels. In some embodiments, this determination may be based on whether the user subscribes to the proposed channel. In other embodiments, the weights may be periodically modified, modified at predetermined times, or the like. In some other embodiments, a publisher may select to have the weights modified. In at least one embodiment, weights may be modified for a given period of time as an experimental period to determine successfulness/value of providing associated channels as proposed channels to the user. If the weights may be modified, then process 700 may flow to block 716; otherwise, process 700 may loop to block 708 to wait for another request for the content for a user.

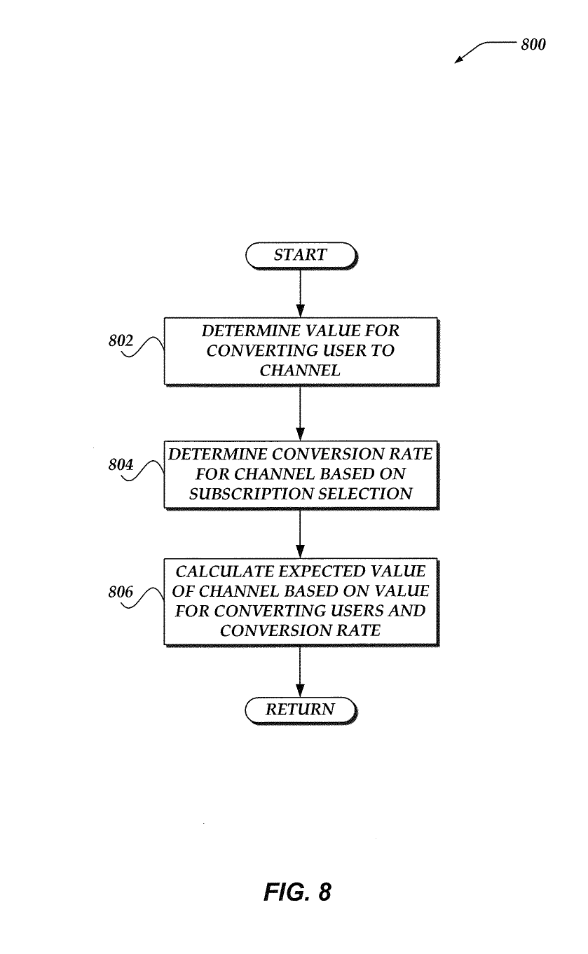

At block 716, an expected value of the proposed channel may be calculated, which is described in more detail below in conjunction with FIG. 8. Briefly, however, the expected value may be an assessment of a benefit for providing the proposed channel to the user. For example, an expected value of one channel may be higher than another channel if more users subscribe to the one channel when proposed compared to the other channel when proposed.

In any event, process 700 proceeds next to block 718, where the weights of the associated channels may be modified based on the expected value of the proposed channel. In some embodiments, the weights of each associated channel may be modified based on an expected value of each channel. In some embodiments, the weights may increase or decrease depending on changes in the expected value. For example, if the expected value for a channel increases over time, the weight for the channel may also increase. Similarly, if the expected value for a channel decreases over time, the weight for the channel may also decrease. After block 718, process 700 may loop to block 708 to wait for another request for the content for a user.

FIG. 8 illustrates a logical flow diagram generally showing one embodiment of a process for calculating an expected value of a proposed channel for a user. In some embodiments, process 800 of FIG. 8 may be implemented by and/or executed on a single network device, such as network device 300 of FIG. 3. In other embodiments, process 800 or portions of process 800 of FIG. 8 may be implemented by and/or executed on a plurality of network devices, such as network device 300 of FIG. 3.

Process 800 begins, after a start block, at block 802 where a value for converting a user to the channel may be determined. In some embodiments, this value may be calculated based on a number of users subscribed to the channel, loyalty of users (e.g., how many times does a user access the channel within a given time period), a number of advertisement impressions, a number of advertisements clicked on in the channel, user engagement with content, a number of clicks on content of the channel, or the like, or any combination thereof. However, embodiments are not so limited and other methods for determining a value for converting a user to a channel may be employed.

Process 800 proceeds next to block 804, where a conversion rate for the channel may be determined. In at least one embodiment, the conversion rate may be based on a subscription selection of at least one user. In some embodiments, the conversion rate may be based on a number of times the channel was proposed to a user (e.g., at block 712 of FIG. 7) and on a number of times those users subscribed to the channel. In at least one of various embodiments, the conversion rate may be a ratio of a number of users that subscribed to a proposed channel to a number of times the proposed channel was provided to users.

Process 800 continues at block 806, where an expected value of the channel may be calculated. In some embodiments, the expected value may be based on the value for converting users to the channel and the conversion rate. In at least one of various embodiments, the expected value may be the product of the value for converting user and the conversion rate.

After block 806, process 800 may return to a calling process to perform other actions.

FIG. 9 illustrates a logical flow diagram generally showing one embodiment of a process for determining which channel to post content. In some embodiments, process 900 of FIG. 9 may be implemented by and/or executed on a single network device, such as network device 300 of FIG. 3. In other embodiments, process 900 or portions of process 900 of FIG. 9 may be implemented by and/or executed on a plurality of network devices, such as network device 300 of FIG. 3.

Process 900 begins, after a start block at block 902, where content may be selected. In at least one embodiment, block 902 may employ embodiments of block 702 of FIG. 7 to select content.

Process 900 proceeds to block 904, where channels associated with the content may be determined based on features of the selected content. In at least one embodiment, block 904 may employ embodiments of block 704 of FIG. 7 to determine channels associated with the content.

Proceeding to block 906, an expected value of each associated channel may be calculated. In at least one embodiment, the expected value of a channel may be calculated by employing embodiments of process 800 of FIG. 8 for each associated channel. For example, the expected value of a channel may be based on a combination of a value for converting users to the channel and a conversion rate of users. In other embodiments, the expected value may be calculated based on a number of users that accessed other content similar to the selected content (i.e., other content with at least one feature that is also a feature of the selected content).

In any event, process 900 continues at block 908 where resources for posting the content to the associated channels may be determined. As used herein, the term “resource” may refer to a number of pieces of content that can be provided and/or published to one or more channels in a given time period. For example, each channel may enable five posts per day. In some embodiments, resources may also refer to a number of pieces of content that a publisher can provide to channels a given time period. For example, a publisher may be able to make 50 posts per day, independent of channel resource restrictions. In some other embodiments, each channel may include a minimum and/or a maximum number of pieces of content that can be provided to the channel for a given time. In at least one embodiment, the minimum and/or maximum number of pieces of content may be determined based at least on preferences of users associated with the channel (i.e., an audience within the channel). In some embodiments, user preferences may include a time users spends accessing the channel within the given time, a number of pieces of content on the channel accessed by the user within the given time (e.g., an average number of pieces of content accessed by a user per day), or the like.

Process 900 proceeds next to block 910, where a subset of the associated channels may be selected for posting and/or publishing the selected content based on the expected value and the resources. In some embodiments, the subset of associated channels may be randomly selected such that channels with a greater expected value are selected more often than channels with a lower expected value. In other embodiments, the subset of associated channels may be randomly selected among the associated channels that may have resources available. In at least one such embodiment, if no resources are available for a channel (e.g., channel has reached its maximum number of posts), then that channel may not be selected. In some embodiments, the subset of associated channels may include a channel that is not associated with the selected content, which may enable the system to explore additional channels unrelated to the selected content.

In at least one embodiment, the subset of channels may be provided to the publisher. In some embodiments, the subset may include a plurality of channels, where the publisher may be enabled to select one or more of the channels to post the selected content.

Process 900 continues at block 912, where the channel selection may be provided. In at least one embodiment, the publisher may select a channel from the subset of channels.

Proceeding next to block 914, the content may be posted, published, and/or otherwise provided to the selected channel. In at least one embodiment, block 914 may employ embodiments of block 412 of FIG. 4 to post content to the selected channel.

After block 914, process 900 may return to a calling process to perform other actions.

FIG. 10 illustrates a logical flow diagram generally showing one embodiment of a process for determining content to cross promote on a channel. In some embodiments, process 1000 of FIG. 10 may be implemented by and/or executed on a single network device, such as network device 300 of FIG. 3. In other embodiments, process 1000 or portions of process 1000 of FIG. 10 may be implemented by and/or executed on a plurality of network devices, such as network device 300 of FIG. 3.

Process 1000 begins, after a start block, at block 1002, where a channel may be selected to cross promote content. In some embodiments, the channel may be selected from a plurality of possible channels by a publisher, editor, audience development staff, marketing team, or the like. For example, a publisher may select Channel A to publish content that was previously published on another and/or different channel. This re-publishing of content may be referred to as cross promoting content between channels.

Process 1000 proceeds to block 1004, where a cross-promotion channel may be determined. In at least one embodiment, the cross-promotion channel may be a channel that content was previously published. In some embodiments, the cross-promotion channel may be determined based on a weight of each of a plurality of channels. In some embodiments, the weight of a channel may be determined by employing embodiments of block 706 of FIG. 7. In at least one embodiment, a channel with a highest weight may be determined as the cross-promotion channel. In other embodiments, a channel with a weight above a predetermined threshold may be determined as the cross-promotion channel. However, embodiments are not so limited and other methods for determining a cross-promotion channel may be employed.

Process 1000 continues at block 1006, where content to publish on the selected channel may be determined. In at least one embodiment, the content may be selected from content previously published on the cross-promotion channel. Such content may be randomly selected, selected based on features of the previously published content and characteristics of the selected channel, selected based on the weight of the channel (e.g., if the weight is based on content, secondary effects of the content, or the like, such as described at block 706 of FIG. 7), or the like, or any combination thereof.

Process 1000 proceeds next to block 1008, where the determined content may be published to the selected channel. In at least one embodiment, block 1008 may employ embodiments of block 914 of FIG. 9 to re-publish content from the cross-promotion channel to the selected channel.

After block 1008, process 1000 may return to a calling process to perform other actions.

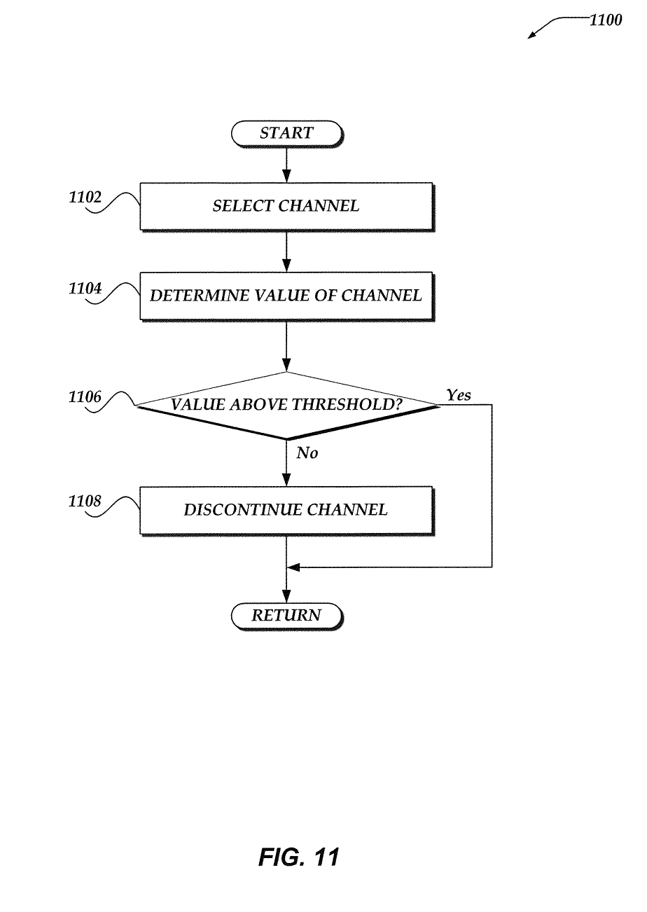

FIG. 11 illustrates a logical flow diagram generally showing one embodiment of a process for determining when to discontinue a channel. In some embodiments, process 1100 of FIG. 11 may be implemented by and/or executed on a single network device, such as network device 300 of FIG. 3. In other embodiments, process 1100 or portions of process 1100 of FIG. 11 may be implemented by and/or executed on a plurality of network devices, such as network device 300 of FIG. 3.

Process 1100 begins, after a start block, at block 1102, where a channel may be selected. In at least one embodiment, block 1102 may employ embodiments of block 402 of FIG. 4 to select a channel.

Process 1100 proceeds to block 1104, where a value of the channel may be determined. In some embodiments, the value of the channel may be determined based on a value for converting user to the channel, such as described above in conjunction with block 802 of FIG. 8. In other embodiments, the value of the channel may be an expected value of the channel as described above in conjunction with block 806 of FIG. 8. In yet other embodiments, the value may be a number of users that are subscribed to the channel, a number of clicks on content per user, or the like.

Process 1100 continues at decision block 1106, where a determination may be made whether the determined value of the channel is above a threshold. In at least one embodiment, the threshold may be a minimum number of clicks on content, a minimum number of subscribed users, a minimum value of the channel, or the like. If the value is above the threshold, then process 1100 may return to a calling process to perform other actions,; otherwise, process 1100 may flow to block 1108 where a channel may be discontinued.

At block 1108, the channel may be discontinued. In some embodiments, discontinuing a channel may include halting future posts of content to the channel, deleting/suspending/removing the channel, or the like. In some embodiments, discontinuing a channel may include removing subscribed users from the channel (e.g., deleting a mailing list of users). In other embodiments, users may be notified that the channel is being discontinued.

In at least one embodiment, if the channel to be discontinued is a child channel, then the child channel may be merged into its parent channel by inviting and/or automatically subscribing the child channel's users to the parent channel. In some embodiments, the child channel may be abandoned (e.g., halt future posts), deleted, or the like. For example, assume the channel to be discontinued is “Europe Economy,” which may have been generated by employing process 400 of FIG. 4 where the selected channel was “World Economy.” In this example, “World Economy” may be the parent channel and “Europe Economy” may be the child channel. So, the users of the “Europe Economy” child channel may be automatically subscribed to the “World Economy” parent channel, and the “Europe Economy” child channel may be abandoned by the publisher. However, embodiments are not so limited and other mechanisms may be employed to discontinue use of one or more channels.

After block 1108, process 1100 may return to a calling process to perform other actions.

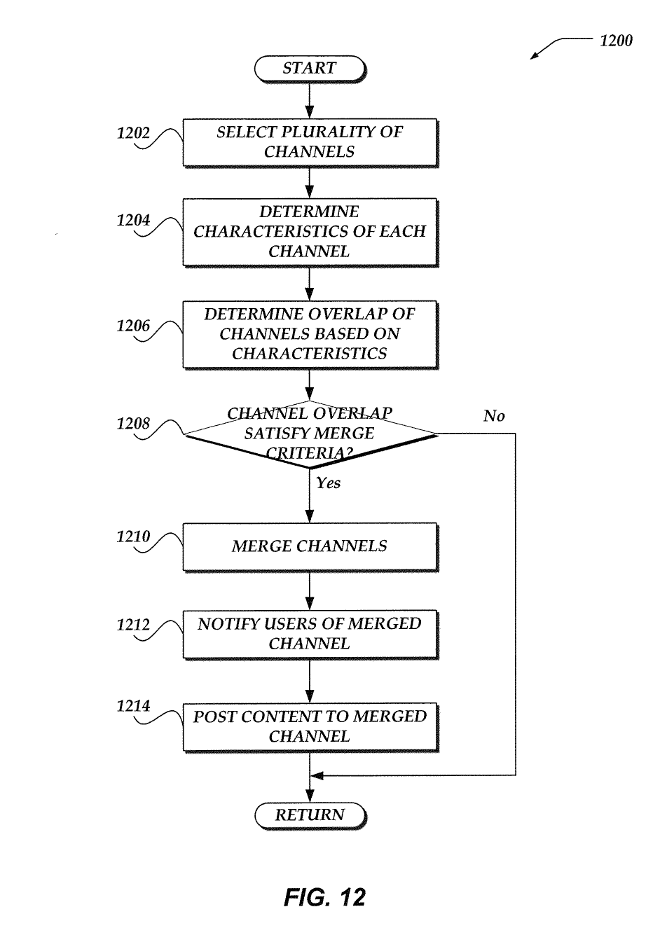

FIG. 12 illustrates a logical flow diagram generally showing one embodiment of a process for determining when to merge multiple channels. In some embodiments, process 1200 of FIG. 12 may be implemented by and/or executed on a single network device, such as network device 300 of FIG. 3. In other embodiments, process 1200 or portions of process 1200 of FIG. 12 may be implemented by and/or executed on a plurality of network devices, such as network device 300 of FIG. 3.

Process 1200 begins, after a start block, at block 1202, where a plurality of channels may be selected. In at least one embodiment, block 1202 may employ embodiments of block 1102 to select each channel.

Process 1200 proceeds to block 1204, where characteristics of each channel may be determined. As described above, each channel may include one or more characteristics about a corresponding channel. In some embodiments, the characteristics may describe the content associated with a channel. In at least one of various embodiments, the characteristics of a channel may include at least one common features of content provided to the channel. In other embodiments, the characteristics may include a list of subscribed users.

Process 1200 continues at block 1206, where an overlap of channels may be determined based on the characteristics. In some embodiments, overlapping channels may include channels with same, similar, and/or common characteristics. For example, a plurality of channels may overlap if a percentage of the subscribed users are common to each channel. In at least one of various embodiments, overlapping channels may be determined by comparing the characteristics of the selected channels.

Process 1200 proceeds next to decision block 1208, where a determination may be made whether the channel overlap satisfies at least one merge criteria. In at least one embodiment, the merge criteria may be based on a predetermined threshold. For example, the predetermined threshold may be a predetermined percentage of users that are common to the overlapping channels. However, embodiments are not so limited and other thresholds and/or merge criteria may be employed.

For example, in some other embodiments, the merge criteria may be satisfied if a successfulness and/or value of a child channel (e.g., a new channel generated by process 400 of FIG. 4) falls below a given threshold. Such successfulness may be determined as described above in conjunction with block 706 of FIG. 7 (e.g., number of clicks on the content, user engagement with the content, a number of advertisement impressions associated with the content, a number of advertisements clicked on while the content is being accessed, or the like, or any combination thereof). So in some embodiments, if a child channel's success diminishes beyond a given threshold, then the child channel may be merged with its parent channel (at block 1210).

If the channel overlap satisfies the merge criteria, then process 1200 may flow to block 1210; otherwise, process 1200 may return to a calling process to perform other actions.

At block 1210, the overlapping channels may be merged. In some embodiments, merging the channels may include combining a mailing list from each of the overlapping channels into a new channel. In other embodiments, merging channels may include discontinuing the overlapping channels (e.g., as described above in conjunction with block 1108 of FIG. 11) and generating a new channel (e.g., as described above in conjunction with block 408 of FIG. 4) for the users of the merging channels. In yet another embodiment, merging channels may include discontinuing one or more of the merging channels and inviting users associated with the discontinued channels to a remaining overlapping channel. In some other embodiments, merging channels may include automatically synchronizing the overlapping channels, such that the content provided to one channel is automatically provided to the other overlapping channels. However, embodiments are not so limited and other methods for merging channels may be employed.

In some other embodiments, if the merge criteria is based on the successfulness of a child channel, then the child channel may be merged into its parent channel by discontinuing the child channel and inviting and/or automatically subscribing the child channel's users to the parent channel.

In any event, process 1200 continues at block 1212, where users of the overlapping channels may be notified of the merged channel. In some embodiments, users may be provided a message, such as, an email and/or text message, that the overlapping channels have merged. In other embodiments, users of the overlapping channels may be provided a request to subscribe to the merged channel. In some other embodiments, the users may not be notified of the merged channel, but may be automatically subscribed to the merged channel.

Process 1200 proceeds to block 1214, where content may be posed to the merged channel. In at least one embodiment, block 1214 may employ embodiments of block 412 of FIG. 4 to post content to the merged channel. As described above, in some embodiments, posting content to one channel may be automatically posted to one or more overlapping channels.

After block 1214, process 1200 may return to a calling process to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer-implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems, which perform the specified actions or steps, or combinations of special purpose hardware and computer instructions. The foregoing example should not be construed as limiting and/or exhaustive, but rather, an illustrative use case to show an implementation of at least one of the various embodiments of the invention.

### Use Case Embodiments

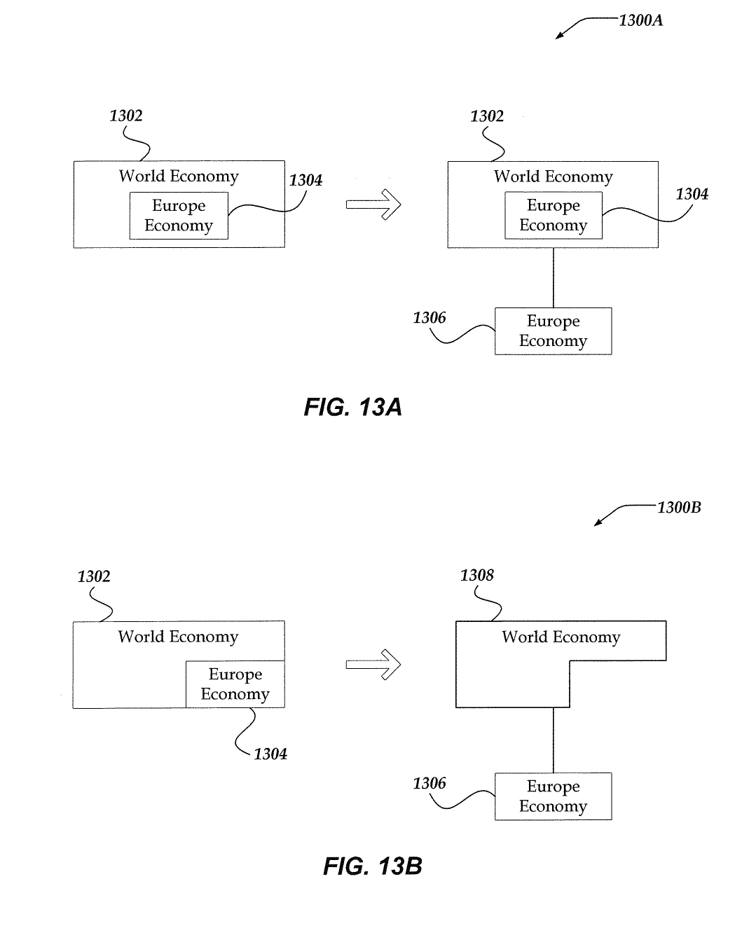

FIGS. 13A-13B show use case illustrations of embodiments of a hierarchy of channels resulting from a generation of a new channel for a sub-interest of another channel. As illustrated in FIG. 13, example 1300A may include channel 1302. Channel 1302 may include one or more sub-interests, such as sub-interest 1304. By performing embodiments of process 400 of FIG. 4, new channel 1306 may be generated based on sub-interest 1304. In some embodiments, content associated with sub-interest 1304 may continue to be posted to channel 1302, as well as new channel 1306. In at least one embodiment, channel 1302 may be a parent channel to new channel 1306.

Example 1300B of FIG. 13B illustrates another example of new channel 1306 being generated by performing embodiments of process 400 of FIG. 4. As illustrated, content associated with sub-interest 1304 may be removed/moved from channel 1302 to new channel 1306. In some embodiments, channel 1302 and channel 1308 may be the same channel, but content associated with sub-interest 1304 may be posted to new channel 1306, but not channel 1308. In at least one embodiment, channel 1308 may be a parent channel to new channel 1306.

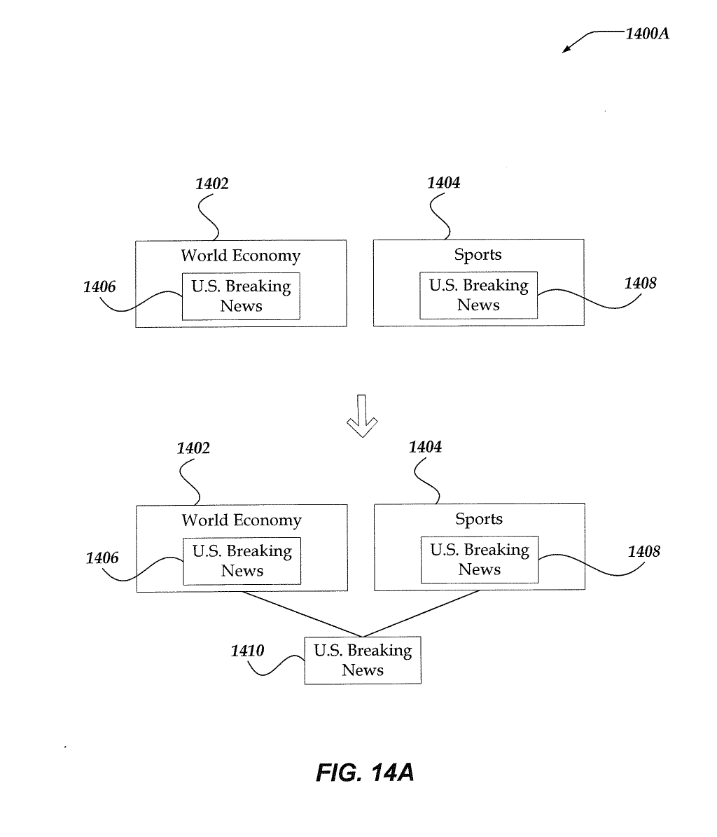

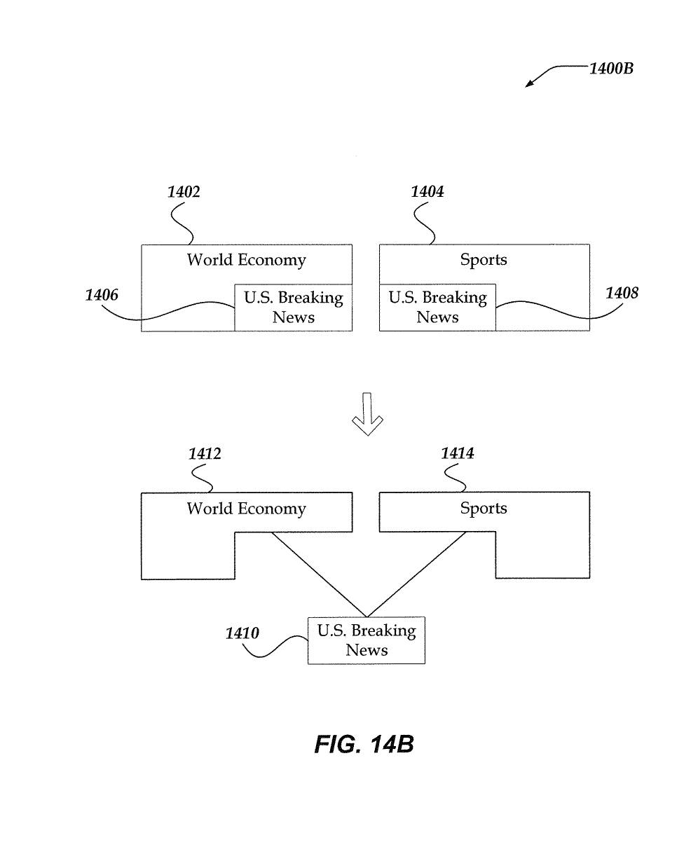

FIGS. 14A-14B shows use case illustrations of embodiments of a hierarchy of channels resulting from a generation of a new channel for a similar sub-interest common to multiple channels. As illustrated in FIG. 14, example 1400A may include channel 1402 and 1404. Channel 1402 may include one or more sub-interests, such as sub-interest 1406. Channel 1404 may include one or more sub-interests, such as sub-interest 1406. In some embodiments, the sub-interests of channel 1402 and 1404 may include the same and/or different sub-interests. By performing embodiments of process 500 of FIG. 5, it may be determined that sub-interest 1406 and 1408 are similar sub-interest (e.g., same features, common subscribers that clicked on related content, or the like). As a result, new channel 1410 may be generated based on sub-interest 1406 and 1408. In some embodiments, content associated with sub-interests 1406 and 1408 may continue to be posted to channels 1402 and 1404, respectively. In at least one embodiment, channels 1402 and 1404 may be a parent channels to new channel 1410.

Example 1400B of FIG. 14B illustrates another example of new channel 1410 being generated by performing embodiments of process 500 of FIG. 5. As illustrated, content associated with sub-interests 1406 and 1408 may be removed/moved from channels 1402 and 1404, respectively, to new channel 1410. In some embodiments, channel 1402 and channel 1412 may be the same channel, but content associated with sub-interest 1406 may be posted to new channel 1410, but not channel 1412. Similarly, channel 1404 and channel 1414 may be the same channel, but content associated with sub-interest 1408 may be posted to new channel 1410, but not channel 1414. In at least one embodiment, channels 1412 and 1414 may be a parent channels to new channel 1410.

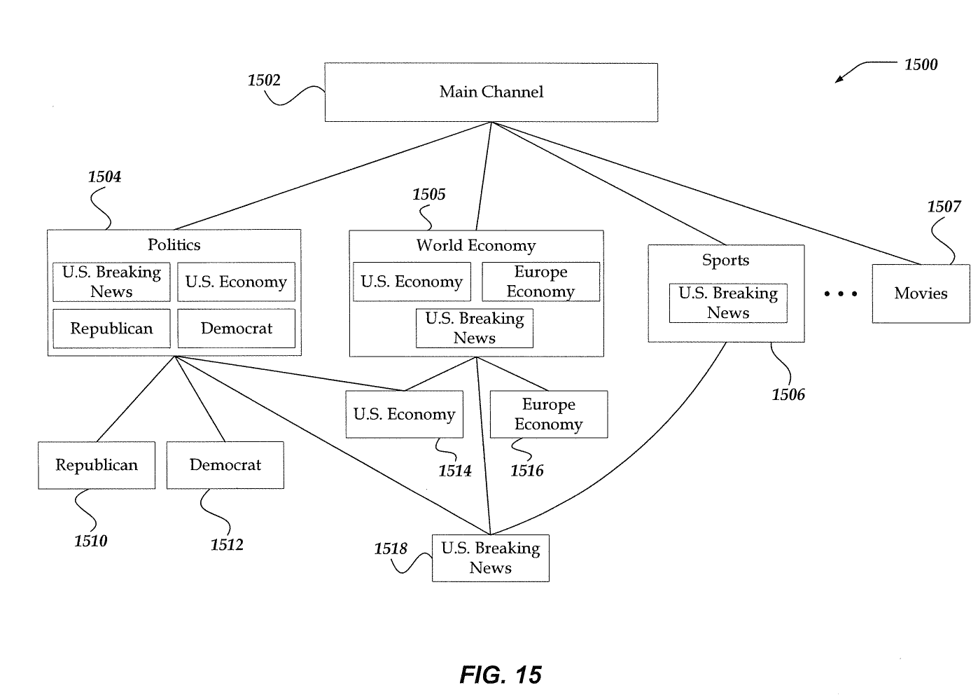

FIG. 15 illustrates a use case of an embodiment of a hierarchy of channels. Hierarchy 1500 may include main channel 1502. Main channel 1502 may be a parent channel to channels 1504-1507. As illustrated, channels 1504-1507 may include a one or more of sub-interests, which may include sub-interests not shown in FIG. 15. By employing embodiments as described above, sub-interests from one or more channels may be determined and new channels may be generated for those sub-interest. For example, channel 1504 may be a parent channel to channels 1510, 1512, 1514, and 1518; channel 1505 may be a parent channel to channels 1514, 1516, and 1518; and channel 1506 may be a parent channel to channel 1518. As illustrated, some new channels may be generated based on similar sub-interests of parent channels. For example, channel 1518 is a child channel of channels 1504, 1505, and 1506. However, embodiments are not so limited and other channels and/or sub-interests may be employed and/or determined

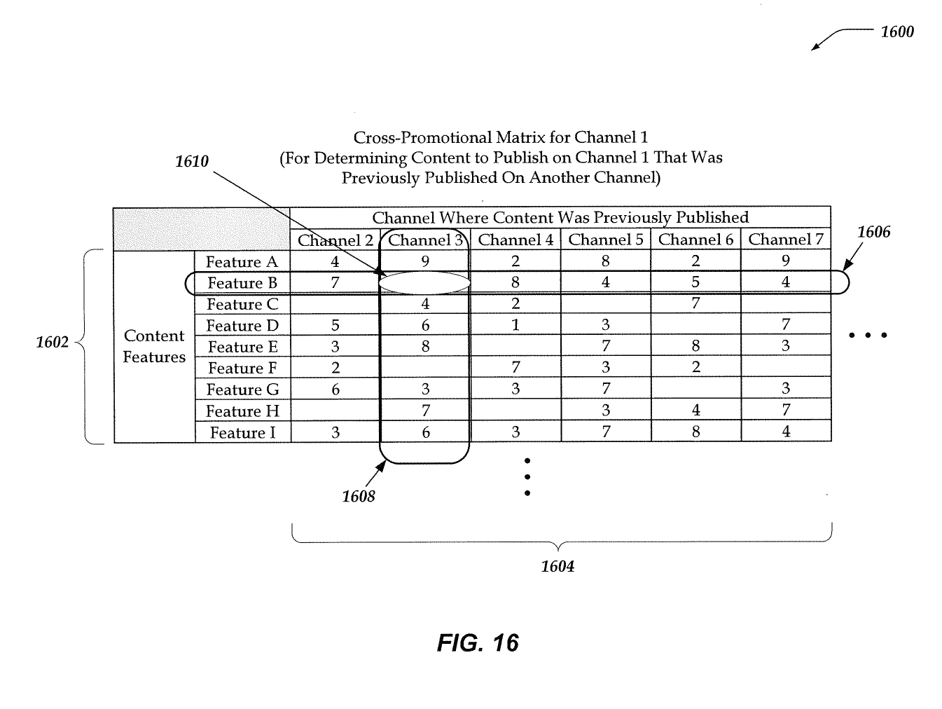

FIG. 16 illustrates a use case of an embodiment of a matrix that may be utilized to determine weights for cross-promoting content on different channels. In some embodiments, a matrix, such as matrix 1600 may be generated for each channel of a plurality of channels. In at least one such embodiment, a matrix may be generated for a channel selected at block 1002 of FIG. 10, i.e., a channel to re-publish content that was previously published on another channel. In this illustration, matrix 1600 may be generated for “Channel 1.” In other embodiments, other matrices (not shown) may be generated for Channels 2, 3, 4, and so on.

Matrix 1600 may include a plurality of columns and a plurality of rows. The columns may include channels 1604 and the rows may include content features 1602. Channels 1604 may include those channels that previously published content. In at least one of various embodiments, channels 1604 may include those channels where content was previously published to both the channel that corresponds to matrix 1600 (e.g., Channel 1) and other channels. Content features 1602 may include a list of each feature of content that was previously published to channels 1604. In at least one of various embodiments, content features 1602 may include those features associated with content that was previously published to both the channel that corresponds to matrix 1600 (e.g., Channel 1) and channels 1604.

The value of each cell in matrix 1600 may be a weight or other value that may indicate a success of cross promotions between channels 1604 and “Channel 1” for corresponding feature of content features 1602. In at least one embodiment, these weights may be determined and/or modified by employing embodiments described herein. In at least one embodiment, a higher number (i.e., weight) may indicate a more successful cross promotion than a lower number.

In some embodiments, an empty cell, such as cell 1610, may indicate that no previous content with the corresponding content feature was published to both the channel that corresponds to matrix 1600 and the corresponding channel. For example, assume Feature B includes articles that discuss Celebrity A—cell 1610 may be blank and/or empty because a same article may not have been published to both Channel 1 and Channel 3 that discuss Celebrity A.

In at least one embodiment, a weight of an empty cell may be calculated and/or estimated based on a combination of the weights of the corresponding content feature (i.e., total feature weight) with the weights of a corresponding channel (i.e., total channel weight. For example, a weight of cell 1610 may be determined based on a combination (e.g., a sum, average, or the like) of total channel weight 1608 and total feature weight 1606. In this illustration, total channel weight 1608 may be a combination (e.g., an average) of each weight of content features 1602 for content that was previously published to Channel 3. Additionally, total feature weight 1606 may be a combination (e.g., an average) of each weight of channels 1604 for content that was previously published with Feature B. In some embodiments, the total channel weight 1608 and/or the total feature weight 1606 may be scaled based on a number of pieces of content previously published, such as a total weight per piece of content. It should be recognized that FIG. 16 is an example of determining weights for cross-promoting content and/or channels and other algorithms and/or mechanisms may be employed. For example, in some embodiments, content may be determined for cross promotion between channels because no previous content was published to both channels (e.g., an empty cell in matrix 1600), which may enable exploration of previously unknown cross promotional channels.

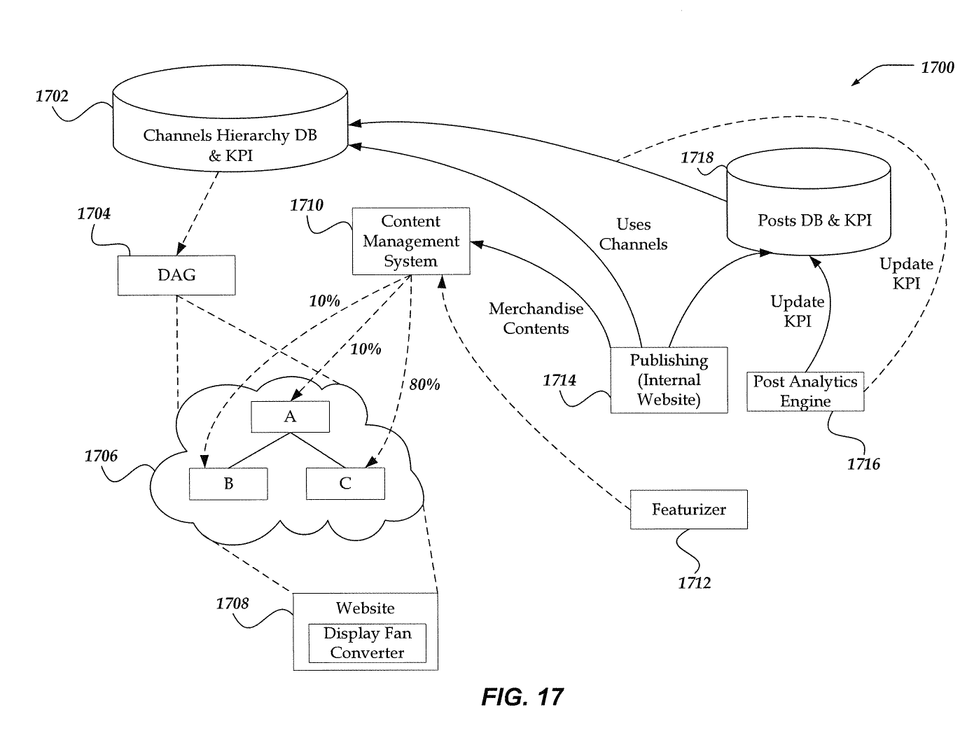

FIG. 17 illustrates a system diagram of a use case embodiment of a system that may be utilized to implement embodiments of the invention. System 1700 may include one or more databases, such as channels hierarchy database 1702 and posts database 1718. In some embodiments, channels hierarchy database 1702 may maintain information that identifies relationships between channels, such as DAG (directed acyclic graph) 1704. DAG 1704 may be illustrated by graph 1706. Graph 1706 may be an illustration of the relationships/hierarchy of a plurality of channels. In some embodiments, channels hierarchy database 1702 may include key performance indicators of each channel, such as a value and/or expected value of a channel.

Posts database 1718 may maintain information about content posted and/or provided to the channels of the hierarchy. In some embodiments, posts database 1718 may include key performance indicators of each post, such as, which users accessed a piece of content or the like.

System 1700 may also include content management system 1710, publishing 1714, post analytics engine 1716, and featurizer 1712. Content management system 1710 may determine a subset of channels to post content. In some embodiments, content management system 1710 may determine a proposed channel to provide to a user that access content on a channel, such as website 1708. Post analytics engine 1716 may determine and/or update key performance indicators for at least channels hierarchy database 1702 and/or posts database 1718. In some embodiments featurizer 1712 may be enabled to analyze content and to determine one or more features of the content. Publishing 1714 may include a website and/or other interface that may enable a publisher to select content, select one or more channels to post content, use a channel to post and/or provide content, or the like. In some embodiments, posting content to a channel that can be accessed by a user of website 1708 may also be referred to a merchandising content.

The above specification, examples, and data provide a complete description of the composition, manufacture, and use of the invention. Since many embodiments of the invention can be made without departing from the spirit and scope of the invention, the invention resides in the claims hereinafter appended.

What is claimed is:

1. A computer implemented method utilizing a computing device for managing channels that publish content to a plurality of users, wherein the computing device performs actions, comprising:
determining, by the computing device, at least a portion of a channel's users that each performs an action on content that share at least one feature for a sub-interest of an interest, wherein the channel publishes, to at least those users that are subscribed to the channel, content that is directed to the interest;
generating a new channel provided that the at least portion of users satisfies at least a criteria for the new channel, wherein the new channel publishes content that is directed to the sub-interest; and
inviting the at least portion of users of the channel to subscribe to the new channel

2. The method of claim 1, further comprising:
determining at least a portion of another channel's users that exhibit at least similar interaction with the sub-interest, wherein the other channel publishes content that is directed to another interest;
wherein the generating of the new channel includes determining if combined at least portions of users for both the channel and the other channel satisfy at least the criteria for generating the new channel; and
inviting the at least portion of users of the other channel to subscribe to the new channel.

3. The method of claim 1, wherein the new channel criteria is satisfied based at least on the at least portion of users being above a threshold.

4. The method of claim 1, wherein the new channel criteria is satisfied based at least on exhibited similar interactions being above a threshold.

5. The method of claim 1, further comprising:
in response to a user requesting content published by the channel, determining another channel based at least on a weighing of the other channel; and
inviting the user to subscribe to the other channel.

6. The method of claim 1, further comprising:
determining a value of user interaction for each of a plurality of channels; and
discontinuing each channel having a corresponding value that is below a threshold.

7. The method of claim 1, further comprising:
if two or more channels overlap based at least on a comparison of channel characteristics, merging the two or more channels into one channel; and
subscribing users for the two or more channels to the one channel.

8. The method of claim 1, further comprising:
determining previously published content to be re-published by the channel based at least on a weighting of another channel, wherein the previously published content was published by the other channel; and
re-publishing the previously published content from the other channel on the channel.

9. A system for managing channels that publish content to a plurality of users, comprising:
at least one network device, comprising:
a memory or storing data and instructions; and
a processor that executes the instructions to enable actions, comprising:
determining at least a portion of a channel's users that each performs an action on content that share at least one feature for a sub-interest of an interest, wherein the channel publishes, to at least those users that are subscribed to the channel, content that is directed to the interest;
generating a new channel provided that the at least portion of users satisfies at least a criteria for the new channel, wherein the new channel publishes content that is directed to the sub-interest; and
inviting the at least portion of users of the channel to subscribe to the new channel

10. The system of claim 9, further comprising:
determining at least a portion of another channel's users that exhibit at least similar interaction with the sub-interest, wherein the other channel publishes content that is directed to another interest;
wherein the generating of the new channel includes determining if combined at least portions of users for both the channel and the other channel satisfy at least the criteria for generating the new channel; and
inviting the at least portion of users of the other channel to subscribe to the new channel

11. The system of claim 9, wherein the new channel criteria is satisfied based at least on exhibited similar interactions being above a threshold.

12. The system of claim 9, further comprising:
in response to a user requesting content published by the channel, determining another channel based at least on a weighing of the other channel; and
inviting the user to subscribe to the other channel.

13. The system of claim 9, further comprising:
determining a value of user interaction for each of a plurality of channels; and
discontinuing each channel having a corresponding value that is below a threshold.

14. The system of claim 9, further comprising:
if two or more channels overlap based at least on a comparison of channel characteristics, merging the two or more channels into one channel; and
subscribing users for the two or more channels to the one channel

15. The system of claim 9, further comprising:
determining previously published content to be re-published by the channel based at least on a weighting of another channel, wherein the previously published content was published by the other channel; and
re-publishing the previously published content from the other channel on the channel

16. A processor readable non-transitory storage media that includes instructions for managing channels that publish content to a plurality of users, wherein the execution of the instructions by a processor enables actions, comprising:
determining at least a portion of a channel's users that each performs an action on content that share at least one feature for a sub-interest of an interest, wherein the channel publishes, to at least those users that are subscribed to the channel, content that is directed to the interest;
generating a new channel provided that the at least portion of users satisfies at least a criteria for the new channel, wherein the new channel publishes content that is directed to the sub-interest; and
inviting the at least portion of users of the channel to subscribe to the new channel.

17. The media of claim 16, further comprises:
determining at least a portion of another channel's users that exhibit at least similar interaction with the sub-interest, wherein the other channel publishes content that is directed to another interest;
wherein the generating of the new channel includes determining if combined at least portions of users for both the channel and the other channel satisfy at least the criteria for generating the new channel; and
inviting the at least portion of users of the other channel to subscribe to the new channel.

18. The media of claim 16, wherein the new channel criteria is satisfied based at least on the at least portion of users being above a threshold.

19. The media of claim 16, wherein the new channel criteria is satisfied based at least on exhibited similar interactions being above a threshold.

20. The media of claim 16, further comprising:
in response to a user requesting content published by the channel, determining another channel based at least on a weighing of the other channel; and
inviting the user to subscribe to the other channel.

21. The media of claim 16, further comprising:
determining a value of user interaction for each of a plurality of channels; and
discontinuing each channel having a corresponding value that is below a threshold.

22. The media of claim 16, further comprising:
if two or more channels overlap based at least on a comparison of channel characteristics, merging the two or more channels into one channel; and
subscribing users for the two or more channels to the one channel.

23. The media of claim 16, further comprising:
determining previously published content to be re-published by the channel based at least on a weighting of another channel, wherein the previously published content was published by the other channel; and
re-publishing the previously published content from the other channel on the channel.

24. A network device for managing channels that publish content to a plurality of users, comprising:
a memory for storing data and instructions; and
a processor that executes the instructions to enable actions, including:
determining at least a portion of a channel's users that each performs an action on content that share at least one feature for a sub-interest of an interest, wherein the channel publishes, to at least those users that are subscribed to the channel, content that is directed to the interest;
generating a new channel provided that the at least portion of users satisfies at least a criteria for the new channel, wherein the new channel publishes content that is directed to the sub-interest; and
inviting the at least portion of users of the channel to subscribe to the new channel

25. The network device of claim 24, further comprising:
determining at least a portion of another channel's users that exhibit at least similar interaction with the sub-interest, wherein the other channel publishes content that is directed to another interest;
wherein the generating of the new channel includes determining if combined at least portions of users for both the channel and the other channel satisfy at least the criteria for generating the new channel; and
inviting the at least portion of users of the other channel to subscribe to the new channel.

26. The network device of claim 24, wherein the new channel criteria is satisfied based at least on the at least portion of users being above a threshold.

27. The network device of claim 24, further comprising:
in response to a user requesting content published by the channel, determining another channel based at least on a weighing of the other channel; and
inviting the user to subscribe to the other channel.

28. The network device of claim 24, further comprising:
determining a value of user interaction for each of a plurality of channels; and
discontinuing each channel having a corresponding value that is below a threshold.

29. The network device of claim 24, further comprising:
if two or more channels overlap based at least on a comparison of channel characteristics, merging the two or more channels into one channel; and
subscribing users for the two or more channels to the one channel.

30. The network device of claim 24, further comprising:
determining previously published content to be re-published by the channel based at least on a weighting of another channel, wherein the previously published content was published by the other channel; and
re-publishing the previously published content from the other channel on the channel.
